(19) United States
(12) Patent Application Publication
(10) Pub. No.: US 2008/0231429 A1
(43) Pub. Date: Sep. 25, 2008

(54) System for electronic documentation and validation of information

(76) Inventors: Barton Leonard, Washington, DC (US); Justin Schaper, Plano, TX (US)

Correspondence Address: Novak, Druce & Quigg LLP, 1300 I Street, N.W., Suite 1000, West Tower, WASHINGTON, DC, 20005, US

(21) Appl. No.: 11/723,406

(22) Filed: Mar. 19, 2007

(51) Int. Cl. G06K 9/00; G06F 15/00; G06K 9/62; H04N 5/235; G06F 7/02; G06F 17/28

(52) U.S. Cl. 340/146.2; 382/128; 348/222.1; 358/1.6; 382/209; 715/268

(57) ABSTRACT

A system, method and computer program for electronic documentation of information, such as medical information, on problem-specific templates that can be validated, in real-time, for completeness. The invention allows the user to organize, display, validate, archive, and export documentation of medical information on such problem-specific templates. By use of a recording device such as a digital pen, the invention combines the speed, ease of use, and familiarity of pen on paper with the data capture, real-time documentation validation, and real-time best practice prompts of traditional EMR systems. Interactive chart validation can be performed at will, rather than the traditional method of medical quality assurance, which consisted of chart review after for the patient had been cared for and discharged. The invention automatically tabulates the number of pre-specified fields with documentation and provides validation to ensure that each documented template has met the pre-specified documentation requirements, documentation suggestions and best health practices guideline prompts.

### BACKGROUND OF THE INVENTION

1. Field of the Invention

The present invention relates to electronic documentation using pen computing systems. More particularly, the present invention relates to system and method for improving the quality of medical care using pen computing systems.

2. Discussion of the Related Art

Over the last 15 years there have been major advances in tablet computing, and pen computing. In general, a tablet P.C. is a personal computer that allows a user to take notes using natural handwriting with a stylus pen on the screen. A tablet P.C. is similar in both size and thickness to that of a yellow legal paper notepad. The tablet P.C. was intended to function as the user's primary personal computer as well as a note-taking device. The user's handwritten notes, which can be edited and revised, can also be indexed and searched or shared via e-mail or cell phone.

A natural extension of the tablet P.C. is pen computing using a digital pen. The digital pen is a writing instrument (normally battery operated) that permits a user to digitally capture a drawing and/or handwritten notes. A digital pen general comes with a docking station in the form of a Universal Serial Bus (USB) cradle so that the user can upload the handwritten notes to a personal computer and/or network. The digital pen looks and feels like a regular ball-point pen and marks the paper just like a conventional pen, with the additional feature that when used with special digital paper, the user can digitally capture what was written with the pen. Digital paper, which can be purchased in traditional pad or sticky-note size, has small dots on it permitting the pen to “see” what has been written. For example, the digital pen will record each inkstroke it writes on digital paper, and will recognize which piece of digital paper was involved, and “sees” exactly where on the paper the inkstroke was placed.

In particular, Anoto A B of Sweden has been very active in the development of digital paper for use with a digital pen. A digital pen using this technology can store up to about 1000 pages of saved digital paper in its memory, and the storage capacity is expected to increase in the future.

Typical digital pens have a camera and save the handwritten data as an image file (such as JPEG or GIF, which depends on the pen's manufacturer). When the user wants to upload saved notes from the pen, all that is required is a simply docking of the pen in its USB cradle. Sensors in the cradle automatically senses the pen's presence, opens the accompanying software application on the user's P.C., and transfers the saved files to a specified folder.

Many digital pens come with handwriting recognition software that allows the user to import their handwritten notes into typed text. In fact, some of the newer high-end digital pens do not have a USB cradle but are wireless, using RF technology such as Bluetooth, 802.11, microwave, or even infrared or optical transmission. These systems permit the pen to send the captured notes or drawings directly to the user's P.C. (or cellular telephone) without wires or fiber optic links. Alternatively, the pen may be able to wirelessly transmit to the docking station, which then in turn also uses a wired or wireless means to provide the data captured by the pen to the digital drivers and the API of the pen, which in turn is provided to the electronic chart module.

For example, the DigiMemo 692, made by ACE CAD Enterprise Co., Ltd. 2F, No. 94 Bao Chung Rd., Hsin Tien City, Taipei Hsien, Taiwan, R.O.C., is a stand-alone device with storage capability that digitally captures and stores everything you write or draw with ink on ordinary paper, without the use of computer and special paper. Then you can easily view, edit, organize and share your handwritten notes in Windows. Other companies, which include IBM, Lenovo, Electravaya, and Logitech, have all been instrumental in advancing the field of digital pens.

One field that has resisted the use of electronic forms is that of medical centers providing acute care, such as emergency rooms and emergency care centers. Emergency room doctors, for example, often must quickly go from patient to patient and delays can be life threatening. However, each critical care patient needs a form filled out (Emergency Medical Record or “EMR”) by the doctor describing symptoms, treatment, etc. Best practice procedures, which help insure the patients receive the highest level of quality medical care, often rely on the emergency forms being filled out completely and accurately.

Traditional EMR systems are complete, but labor intensive, taking time away from patient care. Pen on paper medical records are fast, but do not capture data elements or provide real-time best practice prompts.

The reason that doctors and other medical providers have long resisted the use of electronic entry, including tablet P.C.'s, as they are too bulky and too slow for use under the normal emergency room. Thus, writing up the condition of a critical care patient is still primarily performed in ink on regular paper and then manually transferred at some time later in the process. Sometimes it is too late to capture some of the missing information or provide service according to best practices because the paperwork is not reviewed until sometime later in the healthcare process.

In fact, the pen and paper system suffers from at least the following problems, including (1) incomplete documentation; (2) inability to capture documentation; (3) inadequate real-time assistance in medical decision-making; (4) misplaced or lost medical records; and (5) slow, difficult, or inflexible input of electronic documentation.

Accordingly, there is a need in the art for a system that simplifies the traditional EMR systems and is as simple to use as the pen and paper system of medical recordation.

### SUMMARY OF THE INVENTION

The present invention provides a system, method and computer program (containing executable code on machine readable media) that provides a solution of at least the above-mentioned five problems of the pen and paper system, yet is as easy to use as a conventional pen and paper system, unlike traditional EMR systems.

According to the present invention, a system, method and computer program for electronic documentation of medical information on problem-specific templates that can be validated, in real-time, for completeness. The invention provides a system and method that allows the user to organize, display, validate, archive, and export documentation of medical information on such problem-specific templates. The present invention combines the speed, ease of use, and familiarity of pen on paper with the data capture, real-time documentation validation, and real-time best practice prompts of traditional EMR systems.

The present invention allows for interactive chart validation in real-time (actions done during the patient encounter prior to discharge), rather than the traditional method of medical quality assurance, which consisted of chart review after the patient had been cared for.

The present invention provides the user with the option of writing with a digital pen or a using a tablet P.C., and automatically tabulates the number of pre-specified fields with documentation to ensure that each documented template has met the pre-specified documentation requirements and documentation suggestions.

According to an aspect of the present invention, the user can, at any time while working with a specific template, press the summary button and an on-screen window will display how many of the required and suggested pre-specified fields have documentation (captured ink strokes) at the time of the request. Moreover, the invention also provide s disposition patient button that provides an on-screen window displaying how many required and suggested pre-specified fields have documentation.

The invention provides a system that interfaces with an application programming interface (API) of a recording system, such as the ANOTO API, which uses a digital pen and microdot paper to make ink strokes on the paper that are recorded. The system extracts the data (ink strokes) from the recording system and provides validation, organization, and manipulation validation that provides the medical provider, patient, and medical care facility with state of the art recordation and adherence to Best Practice guidelines.

One advantage of the present invention is that the digital pen will feel as comfortable as one would feel when normally writing with a regular pen on paper, yet providing the ability to validate the pen strokes, and leaving the medical provider with a hardcopy as backup. The digital pen can be either docked into a USB connected docking station, or, can have wireless transmission capabilities using any wireless transmission protocol, including but limited to, Bluetooth, 802.11, 802.11b (WiFi), infrared, microwave or optical technology. the data can be modulated in any known transmission technique if desired, such as CDMA, OFDM, FM, PM, etc. The benefit is the user is immediately provided with both a digital record and a hardcopy duplicate of the handwritten notes, and with the wireless version, with the pressing of a validation button on the pen, the system can validate the information recorded by the pen and activate a transducer in the pen to make it vibrate or emit a sound or other visual, auditory or sensory signal if there is something incomplete with the patient's chart. The templates can be saved as BMP, JPG, GIF or PNG format.

### BRIEF DESCRIPTION OF THE DRAWINGS

FIG. 1 is an exemplary diagram of one way the architecture according for a system according to the present invention can be embodied.

FIG. 2 a diagram providing an example of the relationship of the template element and the chart element.

FIGS. 3A-3F provide some non-limiting examples templates according to the present invention.

FIG. 3G provides a diagram showing one way the invention can be practiced when using a digital pen.

FIGS. 4A-4Z and 5A-5G provide a series of flowcharts some of the various functionalities that can be performed according to the present invention.

FIGS. 6A to 6E are examples of screen images captured from a particular working embodiment of the present invention.

### DETAILED DESCRIPTION OF THE INVENTION

The following examples are provided for purposes of illustration and not for limitation. A person or ordinary skill in the art will appreciate that the examples provided in the description are not the only ways to practice the present invention and there are many variations not mentioned that lie within the spirit of the invention and the scope of the appended claims.

Anoto® technology, which includes the interpretation and transmission of handwritten text and images, is but one way and the best known mode for practicing the invention. However, a person of ordinary skill in the art understands the invention can use other technologies that operate very differently from the aforementioned technology. U.S. Pat. No. 6,698,660 entitled “Electronic Recording and Communication of Information” by Fahraeus et al. and assigned to Anoto A B, is hereby incorporated by reference in its entirety as background material. The technology is a proprietary technology that includes the use of advanced image processing and a complex infrastructure that permits anything written with the pen on the paper to be transformed to digital media. However, it is to be understood that the invention is contemplated to be compatible with any type of electronic paper, including but in no way limited to film substrate-based bendable color electronic paper with an image memory function, such as invented by Fujitsu Laboratories Ltd.®, and/or electronic paper as made of cellulose, which can be made of plants or bacteria, as discovered by professor of molecular genetics and microbiology R. Malcolm Brown Jr., and graduate student Jay Shah at the University of Texas, Austin, which is one of the main structural components of wood and reflects and bends like conventional paper. There are also types of electronic paper discovered by Philips®, Hewlett Packard®, and/or Xerox Corporation®.

Besides using ink and handling just like a normal ballpoint pen, the pen also includes optic means to electronically record the strokes, including but not limiting to a photodiode, digital camera (such as a Charge Coupled Device “CCD”) etc., to record the strokes. In addition, there can be an advanced image processing system and a communication unit, for example, a wireless Bluetooth, WIFI, infrared, microwave or optical transmission connection from the pen to a mobile phone, personal digital assistant (PDA), etc. The pen's movement is registered across the paper and optionally the pressure is also registered, so that the writing can be interpreted and digitalized. Unlike other applications such as hand-held computers, the characters do not have to be written in a special way.

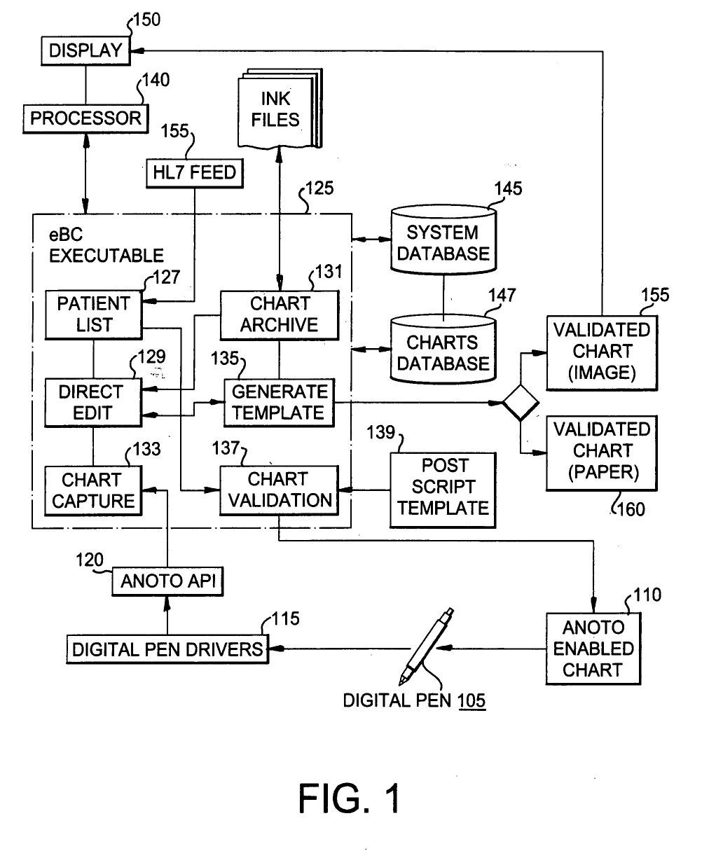

FIG. 1 is a sketch of the architecture showing one non-limiting example of a system according to the present invention. It is to be understood that the sketch is provided for purposes of illustration and not limitation.

An overview of one way that a system according to the present invention can be embodied includes a showing of the interfacing with a recording device (typically a digital pen but not limited thereto) 105, and in this particular example, a chart 110 containing micro dots to record the exact positions of the writing from the digital pen 105, digital pen drivers 115, and an application program interface API 120. This particular chart is sold by Anoto, A. B. but any other system providing a recording device and compatible “paper” which may also include electronic paper, can be used. It should be noted that these items are not what constitutes the invention, but what is used to interface with the invention, and other items, such as the plurality of developed types of electronic paper, including thin-film bendable electronic color paper developed by Fujitsu Laboratories Ltd.®, Hewlett Packard®, or any other system of electronic paper and a compatible writing device can be used instead of the micro-dot paper and a compatible pen system by Anoto. An electronic chart module 125 comprises a series of sub-modules that include a patient list sub-module 127 that provides patient demographic information (preferably in an HL7 format), a direct edit sub-module 129 for updating a chart by adding, deleting and/or changing data, a chart archive sub-module 131 for archiving and exporting completed charts, a chart capture sub-module 133 that communicates with the digital pen via an Application Program Interface (API) 120 for capturing documentation data marked on the chart and recorded by the pen, a chart validation sub-module 135 for determining accuracy of documentation data record in a chart, and a general template sub-module 137 for generating templates to be used in a chart. A Post-Script template 139 can provide the general template sub-module 137 with customized data.

The electronic chart module 125 provides the functionality that goes above and beyond the image recording of the API (in this case an API with Anoto) I to provide the general or customized templates that are recorded on Anoto microdot paper, for example, and the actual categorization and manipulation of the data, in conjunction with processor 140. The processor 140 may be a microprocessor of a typical personal computer, such as an Intel Pentium Dual-Core Processor, or alternatively, the processor could be a part of a server of a local area network and the electronic chart module being stored on machine readable media that is accessible by or arranged in storage of the personal computer, tablet computer, or server.

The processor 140 communicates inter alia with a storage medium comprising a system database 145 and a charts database 147, and the processor communicating with the electronic chart module 125, and the Anoto API 120 (non-exclusively via a chart capture module), and an optional display 150. With regard to the storage medium (databases 145 and 147), both the system and charts databases can be any known type, (e.g. relational) so that certain patient information can be used for a number of features, including but not limited to, adherence to best practice guidelines. With regard to the display 150, any type of device can be used, including but not limited to a PDA, mobile telephone or other remotely connected device. If the remotely connected display is web-based, the instructions for display of data can be provided in an operational code or language that the remotely connected device is capable of using, such as HTML, XML, etc. and the actual image of the documented forms can be in PDF, TIFF, MS WORD, just to name a few possibilities.

HL7 feed 155 contains patient demographic information, such as name, age, insurance of the patient, and the invention automatically brings the patient demographic information into the system from the hospital electronic registration feed (typically HL7). HL7 (Health Level 7) is an ANSI-accredited set of standards for electronically defining clinical and administrative data in the healthcare industry. HL7 is currently the selected standard for the interfacing of clinical in most health-care institutions. HL7 and its members are dedicated to providing a comprehensive framework (and related standards) for the exchange, integration, sharing and retrieval of electronic health information. The standards support clinical practice and the management, delivery, and evaluation of health services, and the “7” comes from application layer 7 in the OSI (Open System Interconnection, which is a standard that provides a common model of protocol layers, defining interoperability between network devices and software) model, which is the highest level where programs talk to each other. Without data standards, healthcare organizations could not readily share clinical information. This information is provided to the patient list module 127, either alphabetically or by registration time, and stored on a rolling timeframe (typically but not limited to 24 hours). Alternatively, the invention allows the demographic information to be manually entered into the system.

The demographic information can be displayed by the display 150. In addition, a list of problem-specific templates is also displayed on the same screen, and the invention permits the user/medical provider to choose which template he/she wishes to use when documenting the condition of the patient, and whether he/she wishes to document with a digital pen 105 or computer tablet (not shown).

Still referring to FIG. 1, if the user chooses a computer tablet, he/she then documents directly on the display screen to mark the image of the problem-specific template with a stylus pen. However, if the user selected the digital pen 105 to document the patient's condition, a printer generates a paper template chart 110 with patent demographics and the chosen problem-specific template. The paper template chart 110 has a special Anoto microdot pattern (or other proprietary digital paper) in accordance with the functionality and user agreements with Anoto, etc.

The user/medical provider than writes on the paper template using a combination of checks, circles, slashes, or handwritten text according to the instructions on the template and the specific layout of the template. The ink strokes recorded can be any type of mark, including but not limited to a dot, a dash, a check-mark in a box, a circled word, a strikethrough, a written word, a forward slash, a back-slash, a multi-curved line and an asterisk.

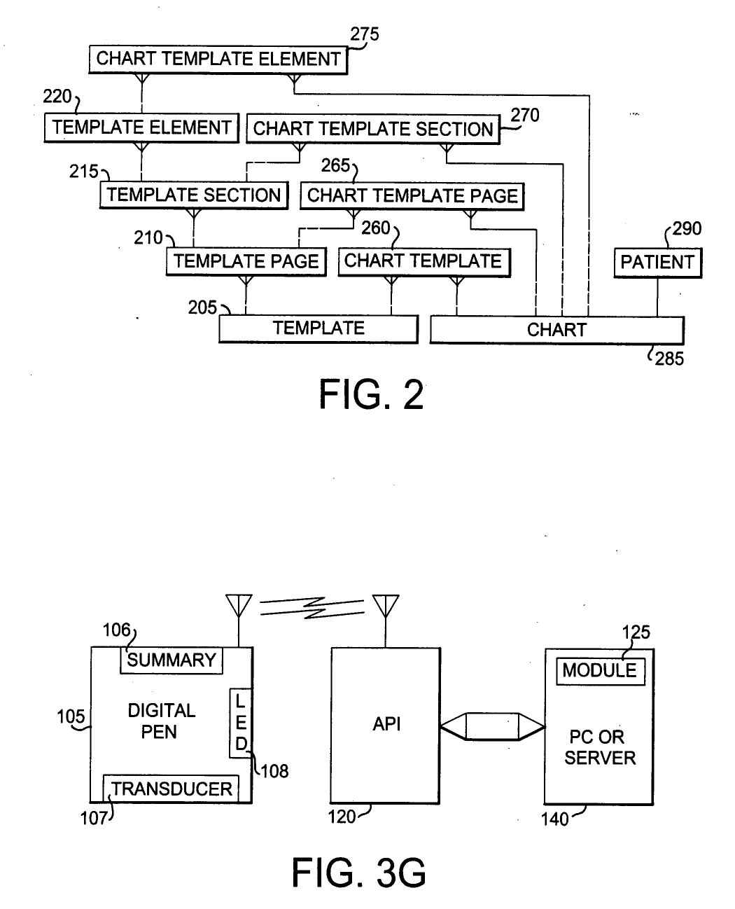

FIG. 2B shows one version of a microdot paper template according to the present invention. It is shown that the paper template typically includes sections for (1) chief complaint; (2) history of present illness; (3) review of symptoms; (4) past medical history; (5) physical exam; (6) medical decision making; and (7) other information pertinent to a patient's medical chart.

According to an aspect of the invention, each of the templates include unique sets of “pre-specified fields” within each section, based on the type of template and what is deemed a required or suggested field. The invention allows either the software or the user to determine what fields require documentation and which fields are suggested to have documentation.

Documentation refers to any mark created with the stroke of a digital pen on a paper template with the micro-dot pattern or the stroke of a stylus pen on a tablet. Thus, the documentation is performed with the familiarity and ease of a regular ink pen. The digital pen has a similar weight and feel of a normal pen and actually writes with a ballpoint pen tip. The ink strokes are recorded by a camera at the tip of the digital pen.

At any point during the patient encounter, the medical provider can dock the digital pen into a USB wired or wireless docking device that communicates with the device on which the electronic chart module is stored. Within seconds, the users ink strokes are transferred into a digital record that can be viewed on-screen. The invention includes keeping track of the particular template selected for the patient, and does permit the use of multiple templates by multiple users in any sequence. The documented templates transferred from the digital pen are organized and displayed on-screen 150 for the medical provider or administrator. It should be understood that while USB is a preferred system for having the docketed pen communicate with the validation system, any other communication protocol can be used, and the writing device or pen may not have a docketing station at all.

According to the present invention, the chart validation sub-module 135 performs interactive chart validation in real-time, either automatically after docking or by the medical provider pressing or clicking on the summary button while working with a specific template, and an on-screen window will display how many required and suggest pre-specified fields have documentation at that point in time. An image 155 of the validated chart will appear on-screen, and the paper chart 160 can be saved for backup as a validated chart.

The invention provides the medical provider with the ability to complete, or document more ink strokes for the templates that have been validated and deemed incomplete based on a minimum number of pre-specified fields with captured ink strokes. The medical provider can complete or update the template in two different ways:

(1) document more ink strokes with a stylus pen on a tablet computer screen; or

(2) document more ink strokes on the original micro-dot paper template with a digital pen.

Upon patient disposition at the end of the patient encounter, the invention automatically archives and exports the completed electronic template. Therefore, the documentation can be retrieved at a later date and can be sent directly to a medical records warehouse or billing company.

In another embodiment of the invention, the digital pen 105 transmits wirelessly to an access point of a LAN, using protocols such as 802.11 or Bluetooth, and the chart validation module provides an output that the document did not pass validation because of either a missing item or an indication that an action does not appear to fall within best practice guidelines.

For example, there can be more than just demographic information being downloaded to the electronic chart module, such as a patient's list of current medications, chronic illnesses, and/or drug allergies. Contraindication software is well-known and available at most major pharmacies. The invention can use a contraindication alert and take it to a new level heretofore unknown in that a medication or treatment prescribed can be compared to the record of the patient's illnesses and current medications. In the case that a treatment or medication is prescribed that could be potentially harmful to the patient, a warning can be displayed on screen that alerts the medical provider that the prescribed treatment may conflict with the chronic ailments or medications of a patient.

One example of contraindication warnings would work as follows: The patient may be a suffering from a chronic illness such as Type II Diabetes, and may be taking 15 MG of pioglitazone (Actoplus Met®). The patient came to the emergency room because he was having chest pains and a diagnostic procedure using an injectable iodinated contrast material was prescribed.

Referring to the above example, with the inclusion of a feature, including but not limited to an Optical Character Recognition Feature, upon docking of the pen, and/or clicking or pressing of the summary button, or any type of actuation means (such as shaking the pen, or provided a spoken command), or the passage of a predetermined interval of time, the chart validation module can compare medications or treatments prescribed with medications currently used or provide this information to a known contraindication software system, and a warning can sound or flash on the screen to let the medical provider know it is recommended that the use of the pioglitazone medication be stopped temporarily around the time of the procedure, and if possible to probe the patient to find out when was the last time he took his medication. While it is normally within the expertise of a medical provider to know all of the drug interactions that can cause bad reactions or ineffectiveness of the prescribed medication or treatment, the validation can serve as a precautionary measure to improve patient care.

The aforementioned validation including contraindications would best serve the patient if the validation were performed as close to real-time as possible. As the docketing of the pen and the reading of a display screen for each patient would be cumbersome in many high-pressure situations such as an emergency room, where a physician must often make rounds from patient to patient all needing critical emergency care as fast as possible, the invention, particularly when used with a pen that transmits wirelessly, can signal the pen to alert the doctor as soon as possible of a potentially serious problem that is outside of the best practice guidelines

The above-mentioned feature would improve upon the docking of the pen to transfer the information, because the mass docking of information essentially transfers the information in batch or group subsequent to the patient examination, and a prescribed medication or course of treatment might have already been provided to the patient before the system could provide a warning to the physician. As the ability to store data in smaller areas continues, there may not be a required docketing of the writing device, as it may have all of the functionality and communication hardware and firmware resident in the writing device itself. The present invention is compatible with a vast array of input/recording systems, although the recording of actual handwriting is preferred.

Another non-limiting embodiment of one way the invention can be practiced includes a warning system for a writing device in an electronic documentation and validation system, including a writing device that electronically records handwritten information on a chart, the writing device having drivers and an Application Program interface (API), and further including a summary button to request validation of recorded information. As shown in FIG. 1, an electronic chart module 125 including a chart capture sub-module communicates with the writing device via the API. A validation sub-module validates documentation data entered on the chart when the summary button of the writing device has been activated; and a warning means including an alarm arranged on or within the writing device notifies a user of the writing device of an error found by the validation sub-module.

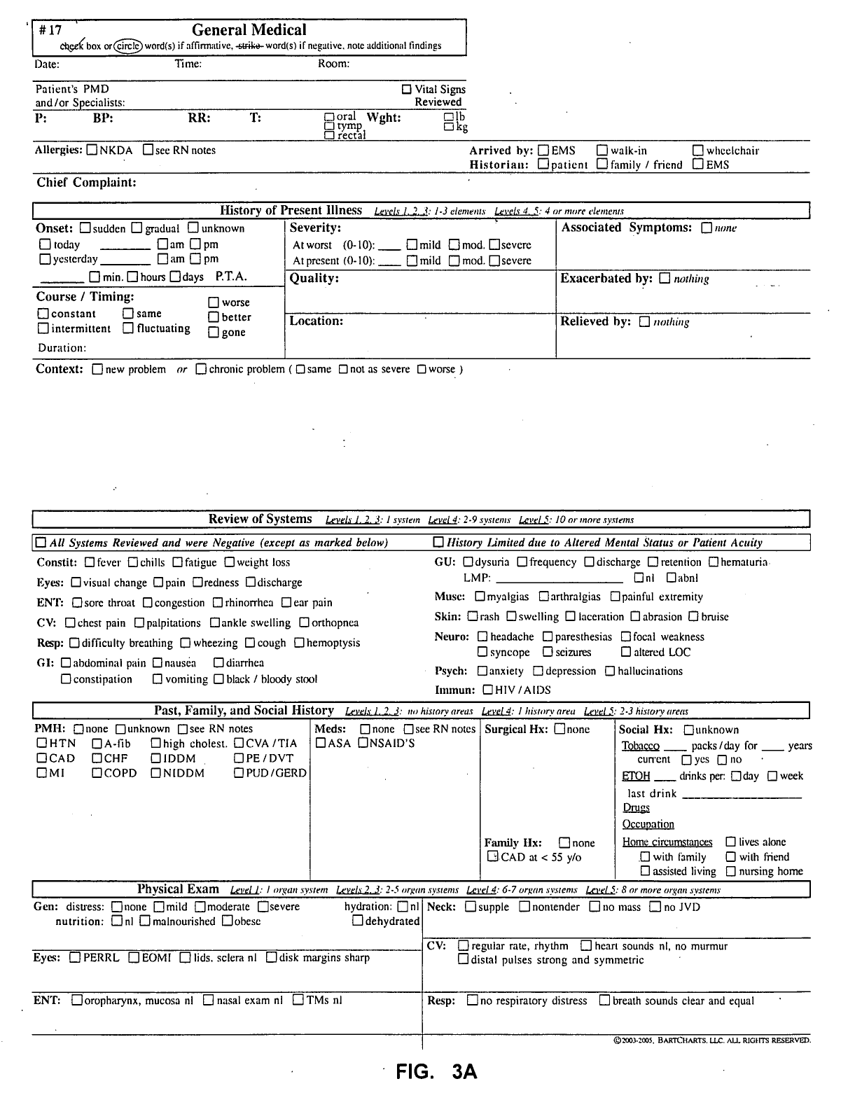

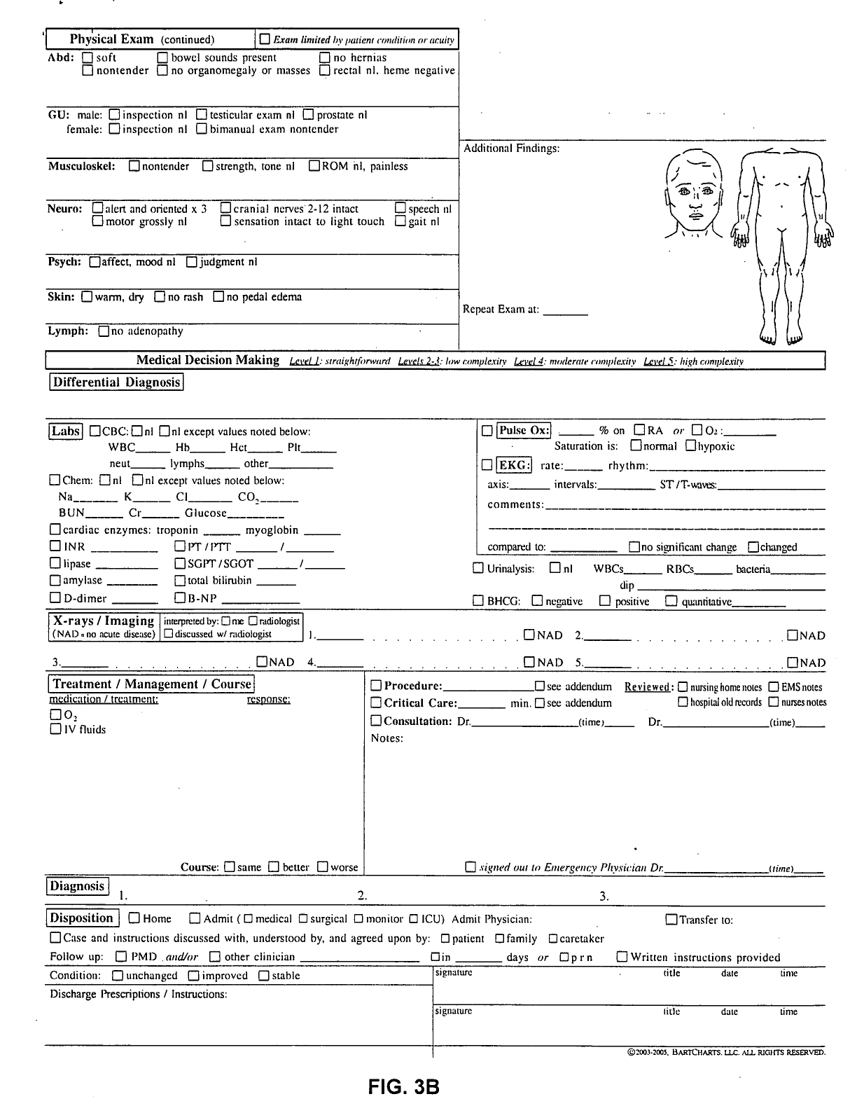

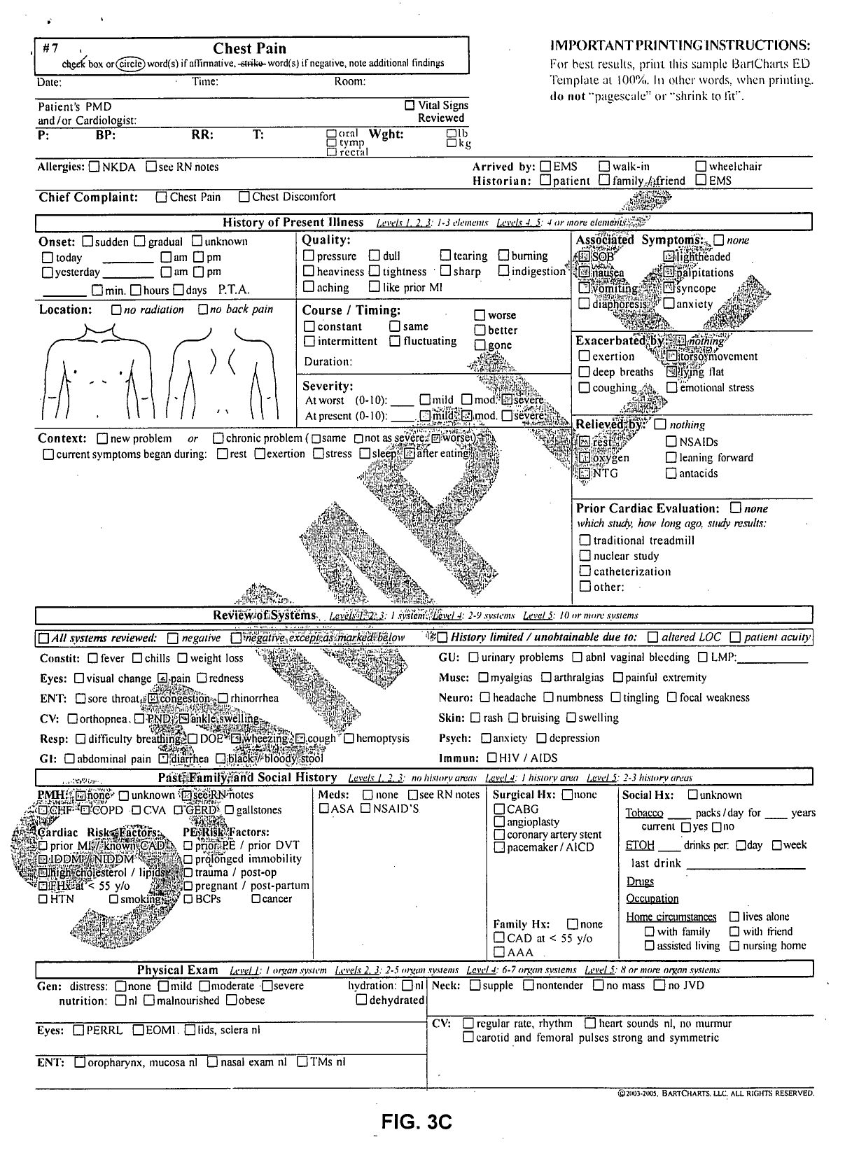

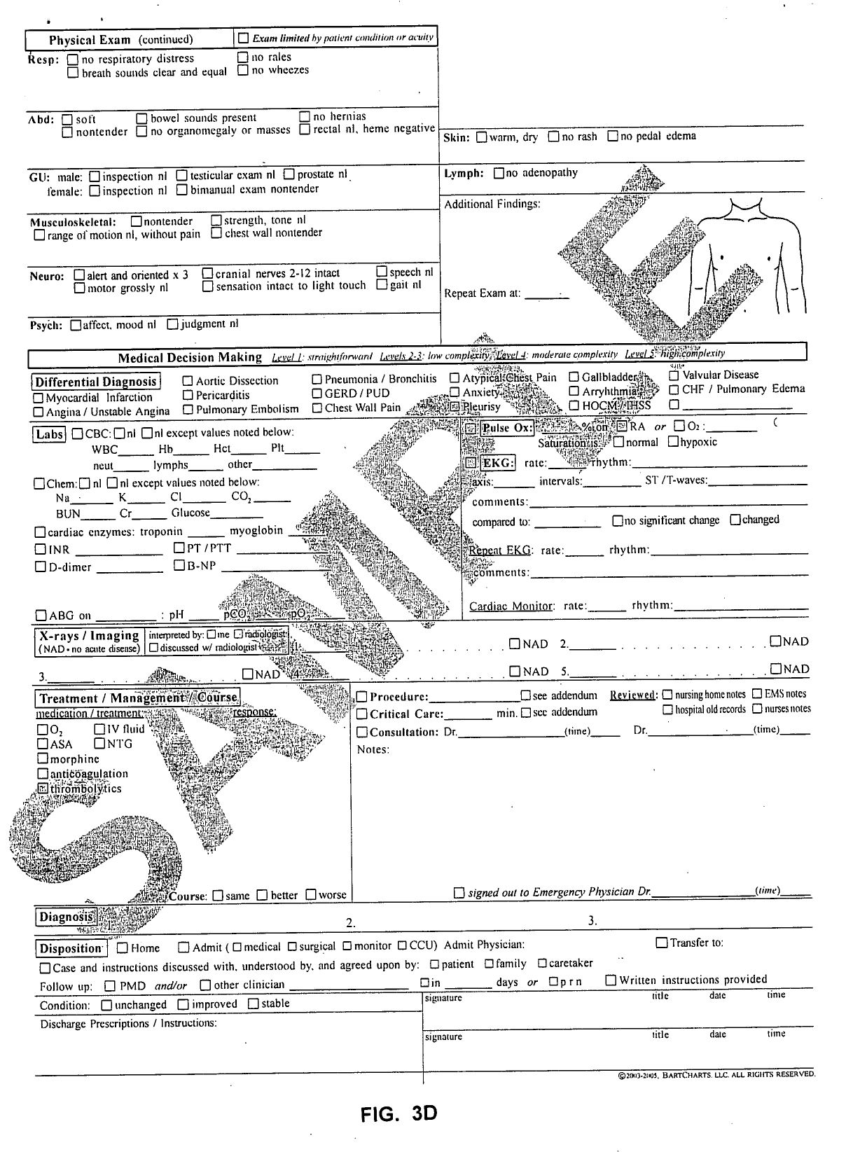

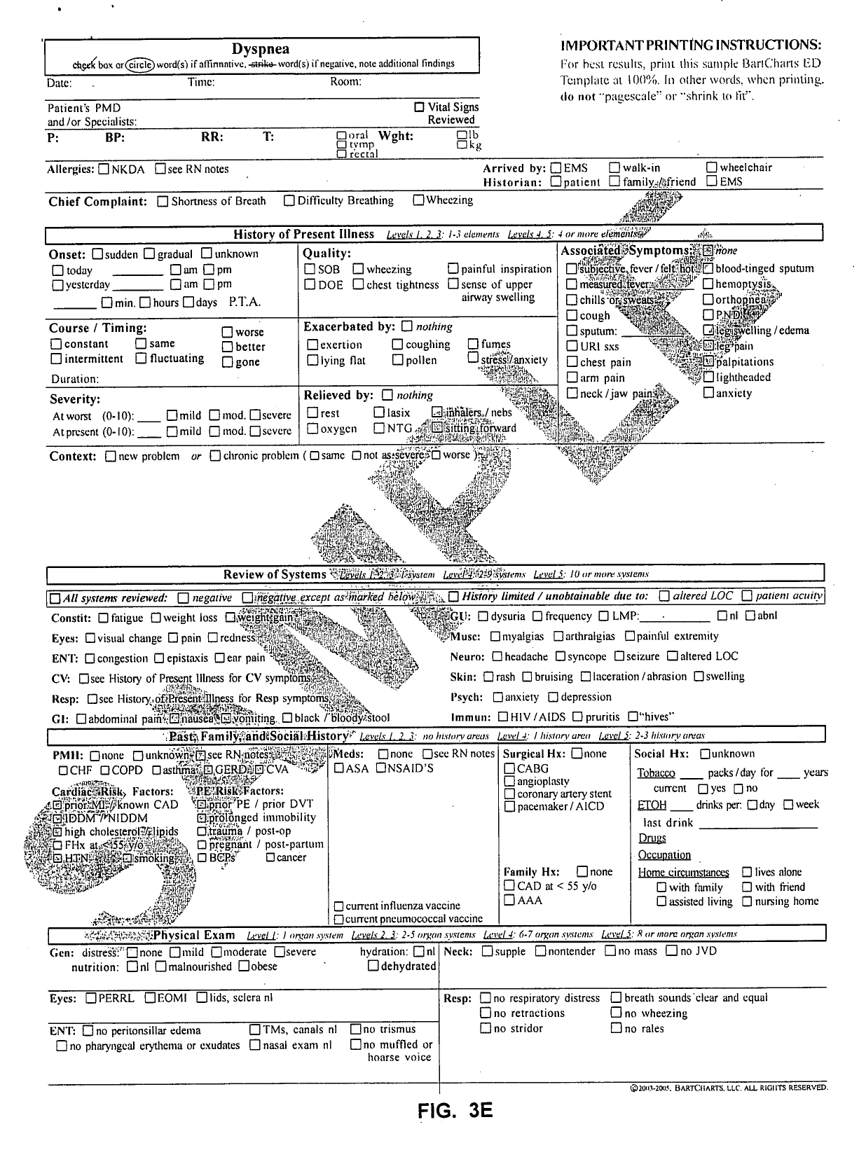

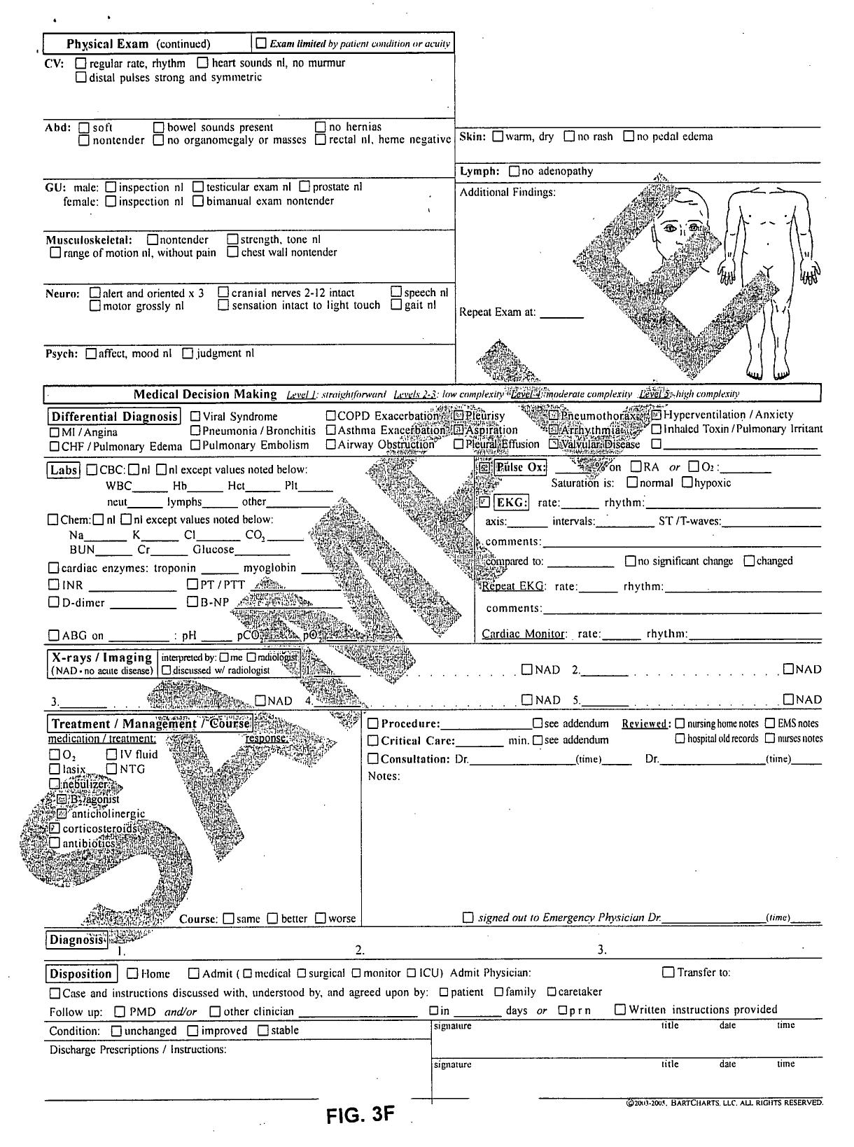

As shown in FIG. 3G, the writing device comprises a digital pen 105 and the chart comprised of a material containing an array of microdots for recording ink strokes, and the warning means includes a range of warnings to the writing device to let the use know about the severity of the error based on the type of warning.

Still referring to FIG. 3G, one way the medical provider can be alerted that something on the template is outside of best practice guidelines is to equip the digital pen 105 with a transducer 107 that can be activated by communication between the invention and the API 120 of the digital pen 105, for example, a piezoelectric or electro-restrictive transducer within the pen and a small button 106 that is a “send” or “summary button”, wherein upon activating the button, the pen communicates with the API 120 of the pen software and requests validation from the electronic chart module 125 of the data recorded by the digital pen, which permits the electronic chart module 125 to receive the data marked on the template by the medical provider with the pen, and to perform a validation function in real-time.

Still referring to FIG. 3G, the data can be sent wirelessly to the API periodically or as a certain number of strokes are recorded, but the summary button would signify to the API that the data recorded on the template is complete and ready for validation by the electronic chart module. If the system detects a serious problem (problems accorded a predetermined level of severity) as a result of potential treatment or omitted data, the system can communicate with the API of the digital pen 105, which in turn, can make the pen vibrate or beep via transducer 107, or flash LEDs/LCD 108 or display a warning to signify to the physician that there is a problem requiring/suggesting that the medical provider check the screen of an associated display device (such as a PDA, mobile telephone or P.C.) to see what is the warning.

Still referring the warning feature described hereinabove, the warnings can be classified according to severity where there would be no vibration, a small degree of vibration, or significant vibration, or the frequency, duration or volume of tones or beeps could change.

Alternatively, the digital pen 105 can have in addition to or instead of a transducer 107, one or more light emitting diodes 108 or a liquid crystal display 108, for example, that could be color coded, flash according to severity, or in the case of LCD, even display a code or a few words describing the alert. Thus, upon the API of the digital pen receiving a specific output from the electronic chart module, the digital pen could signify to the position that there is a serious problem, or in the alternative, flash an all-clear signal or sound (green light, or a different tone or different duration), so the physician, with the click of a button on the digital pen, can determine if there is a problem with best practice guidelines or omitted data in real-time.

A person of ordinary skill in the art understands that vibration, beeping, flashing, and/or other signaling functions are already in use in devices such as mobile telephones. One such example of a notification system that interfaces with computer systems is disclosed in U.S. Pat. No. 6,934,955 to Nickum entitled “Event Notification Within a Local System” and is hereby incorporated by reference in its entirety as background material showing one way that such notification to the digital pen (and thus to the medical provider) can occur. An interface of the system according to the present invention providing chart validation and notifying the digital pen interface to provide a warning signal directly to the pen provides a novel and non-obvious way of warning a medical provider who would only need a modified digital pen to be made aware of the warning.

In addition, the codes or types of signals can signify to the medical provider whether a problem requires further investigation at the moment, where he/she may need to check the display of a PDA, mobile telephone, tablet, or other display device right away, or the issue can be deferred for determination at the end of a physician's shift, or during a quiet period in the emergency room, (which is far more the exception than the rule). The transducer and/or LCD display or LED display are small and can be embedded within or on the surface of pen and would not significantly increase the pen's size, weight, feel or power use.

FIG. 2 is a diagram of the relationship between template 205 and patient chart 280. Templates are the basis of the generation of customized chart templates, from which patient charts are generated when filed in with the appropriate information. The template 205 is typically comprised of at least one or more template pages 210, having one or more template sections 215, which are comprised of template elements 220 that are used to customize/generate Chart templates elements 270 for each medical provider. The chart templates 260 include a chart template page 265 based on the template page 210, and a chart template section 270 based on the template section 215. Ultimately, after examining the patient 290, the chart is filled out with the HL7 data (such as demographics) and the information provided during the examination.

There are many different types of templates 205 that can be customized into chart templates to follow hospital procedures, etc.

For example, FIGS. 3A-3F show samples of general medical complaint templates (FIGS. 3A-3B), and symptom specific templates, such as chest pain, (FIG. 3C), physical exam (FIG. 3D), dyspnea (i.e. difficulty breathing, FIG. 3E), injury or fall, pediatric, rash, etc. The templates can be set up with customized sections, prompts or questions to ask the patient, and the answers will be used to generate charts containing the information deemed particularly important by the medical provider, the hospital, and best practice guidelines.

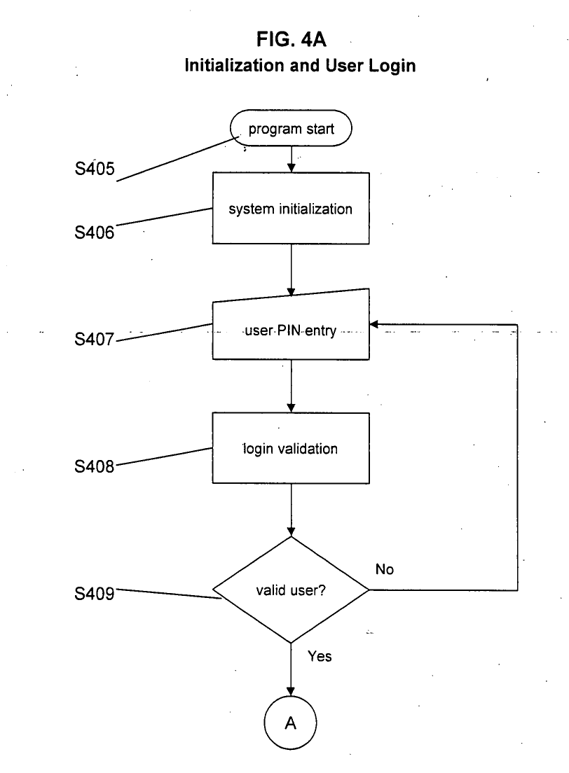

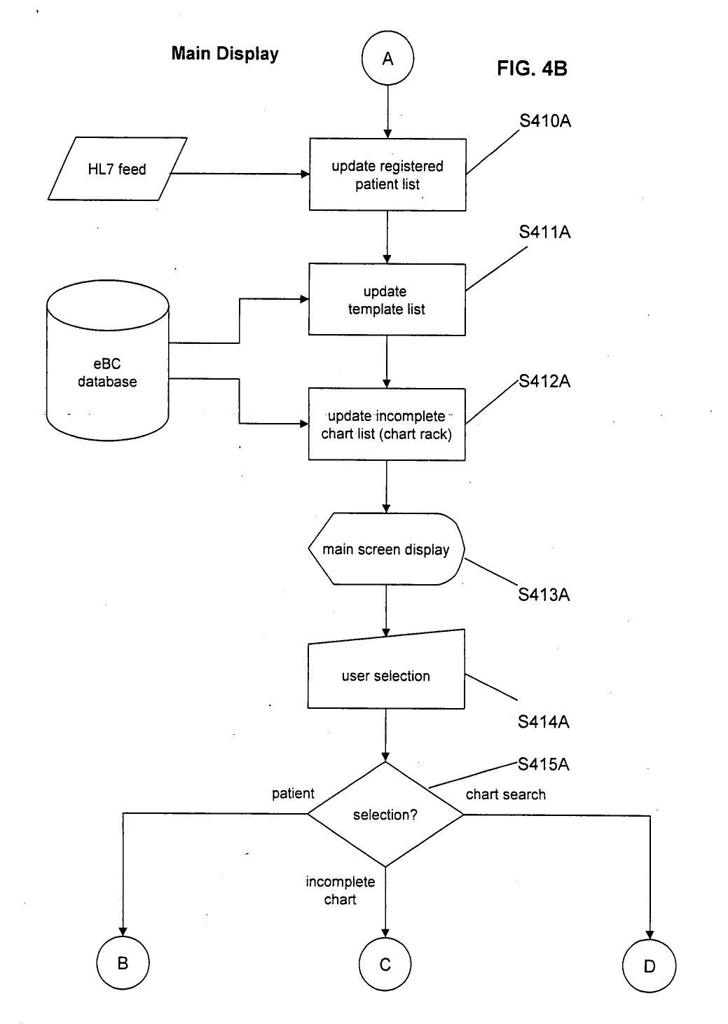

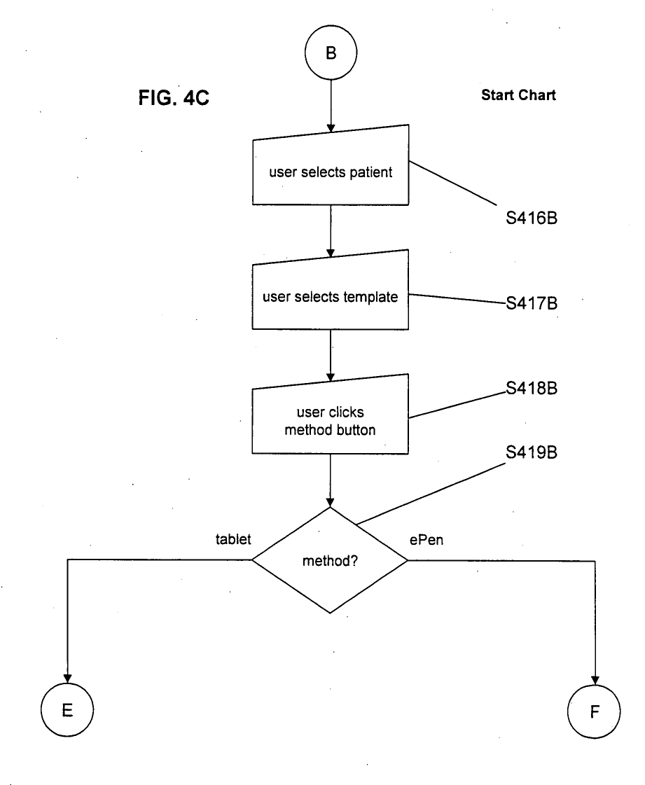

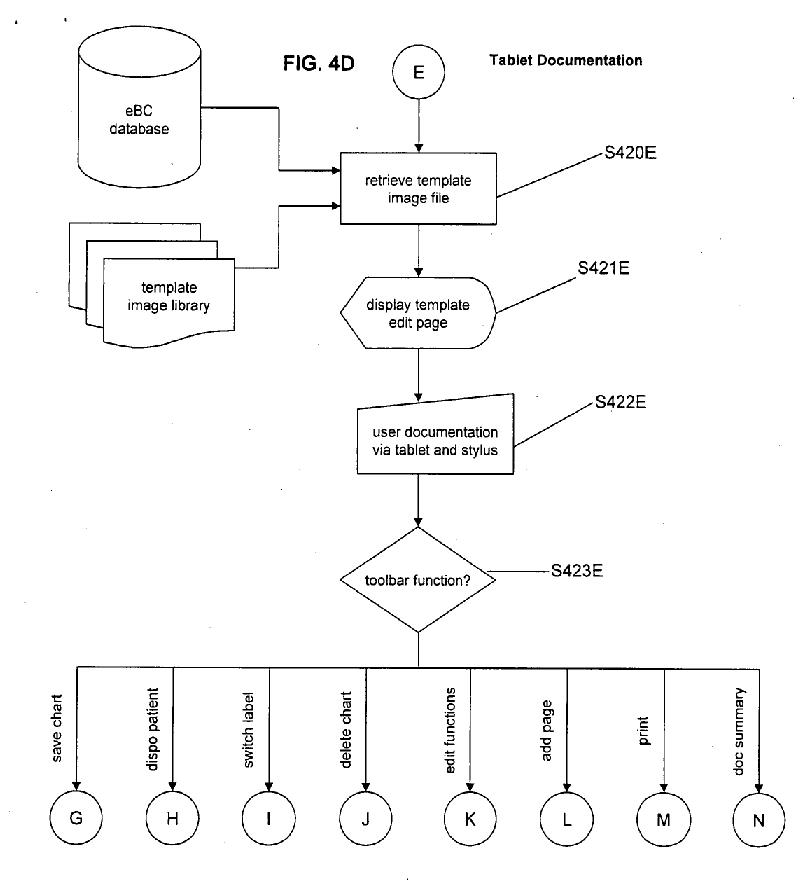

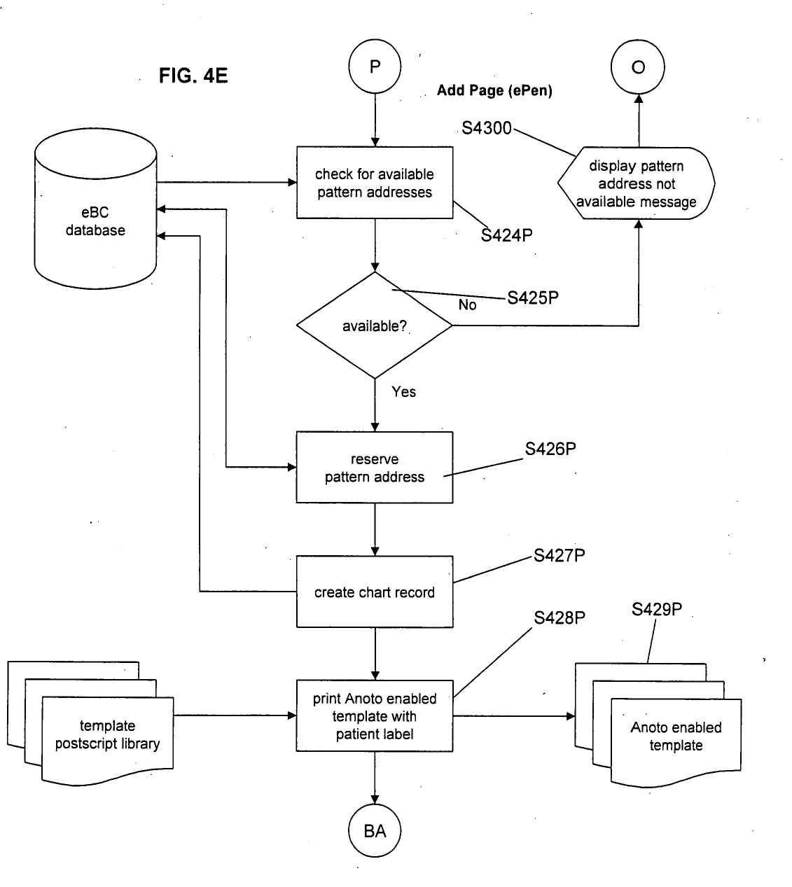

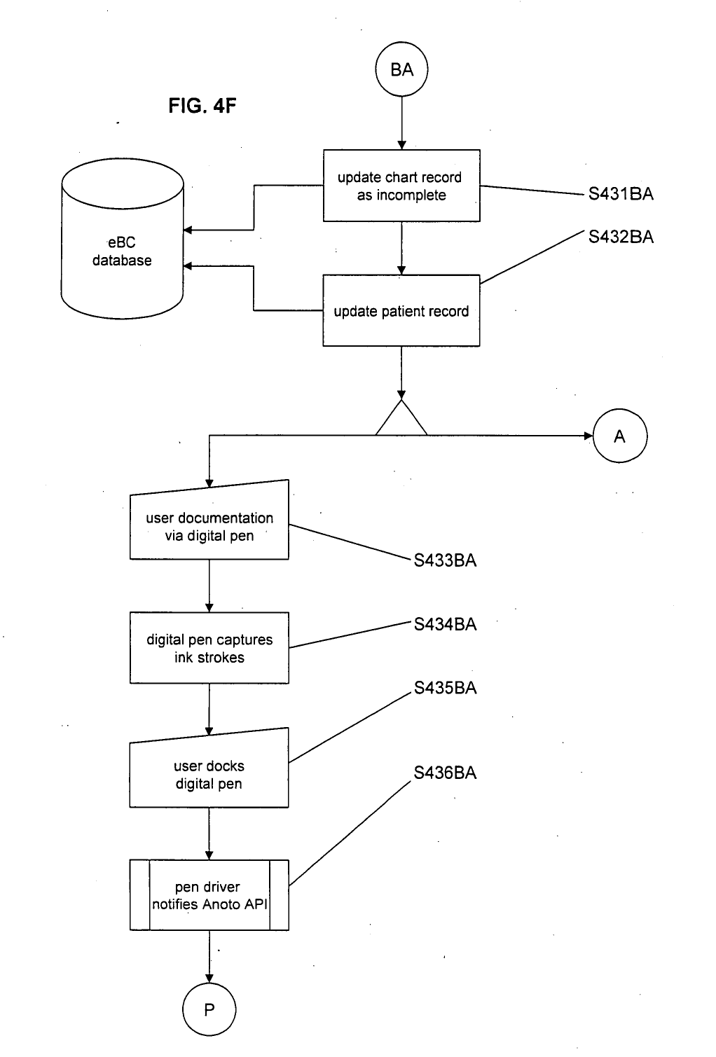

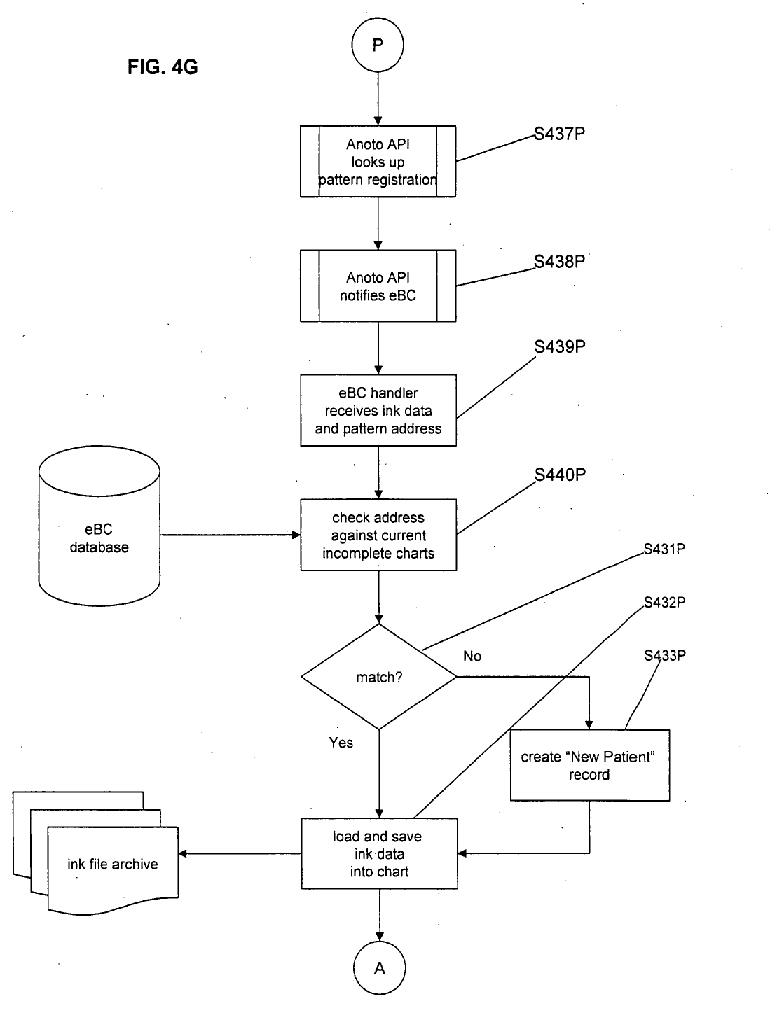

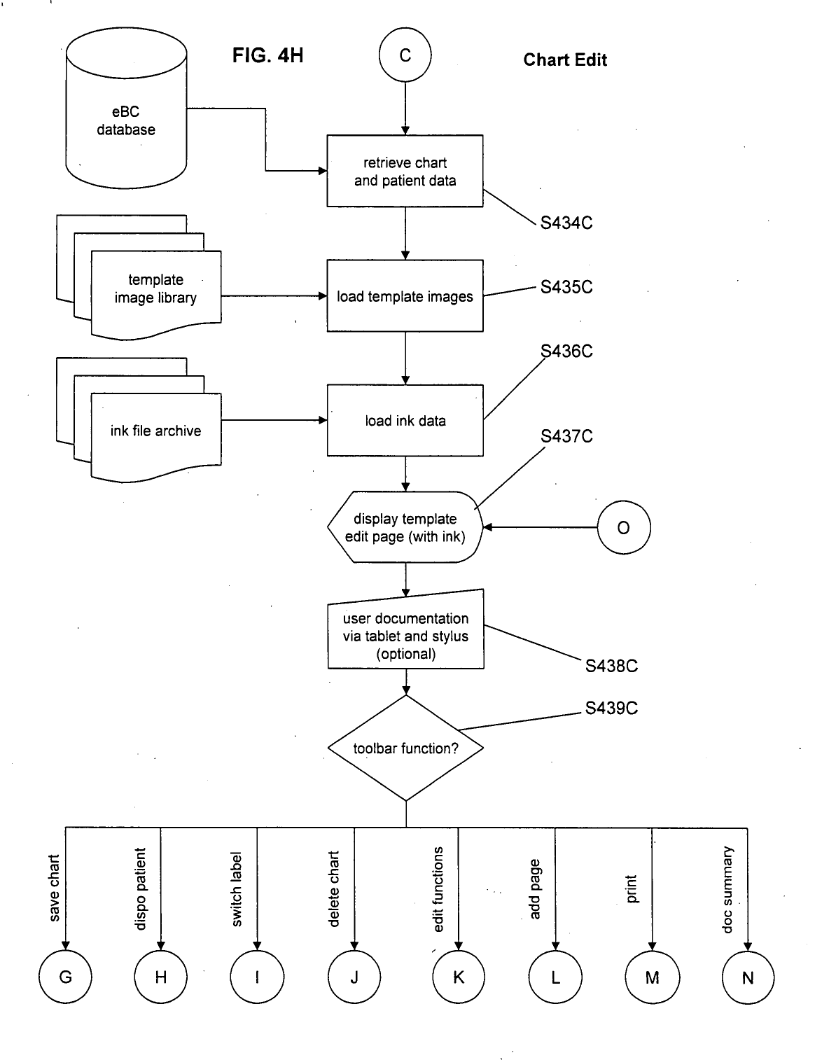

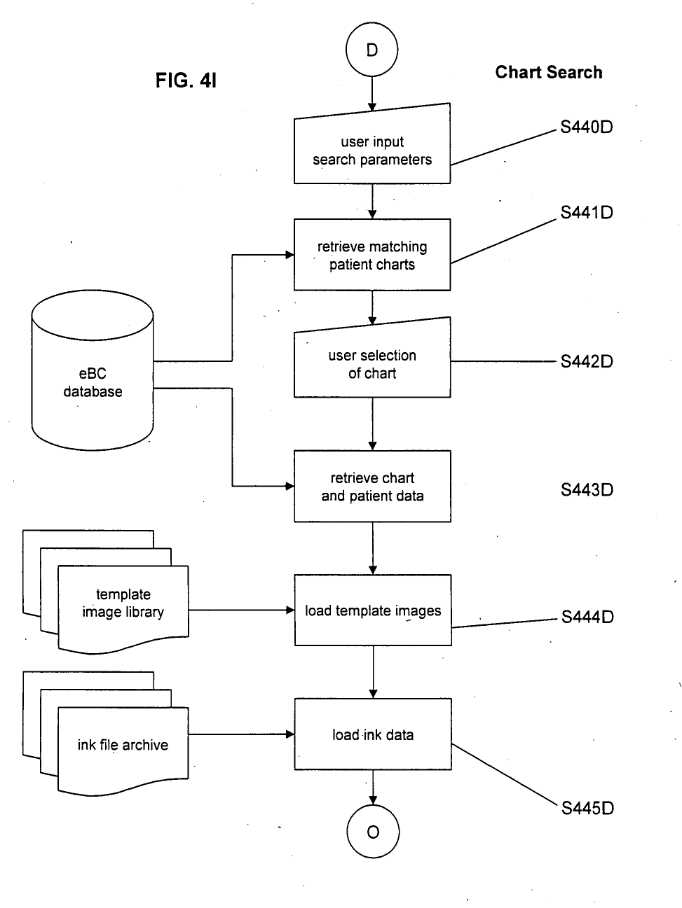

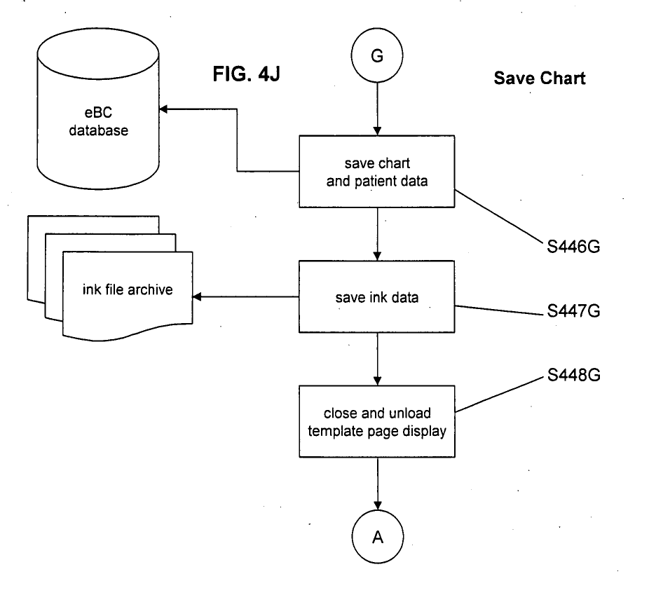

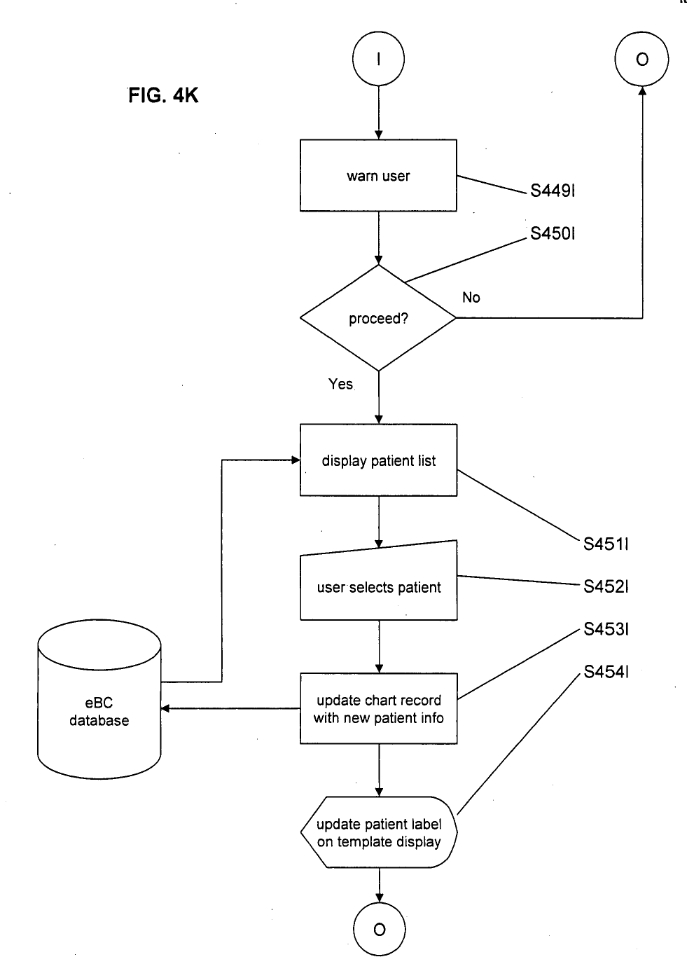

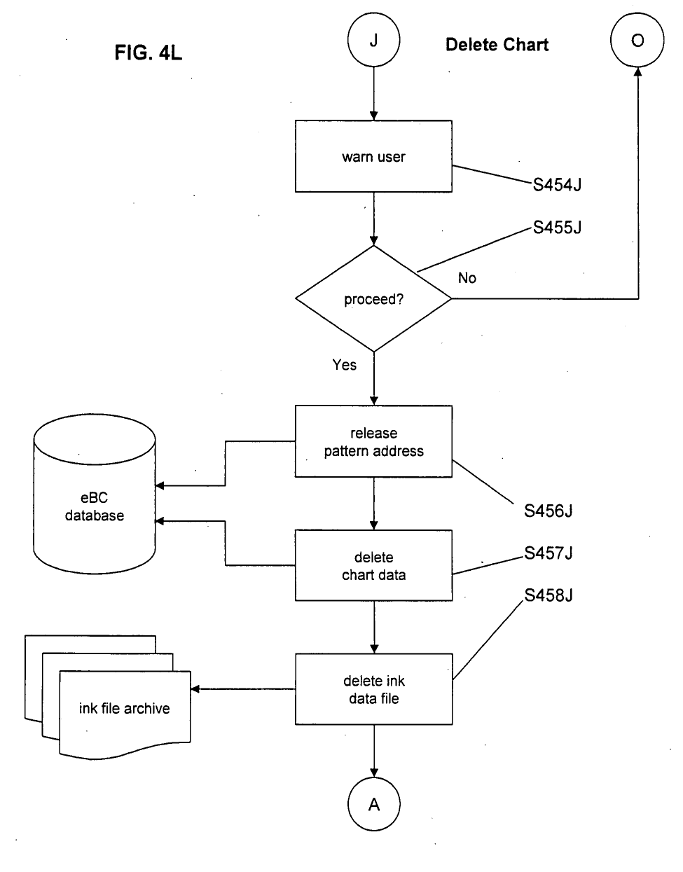

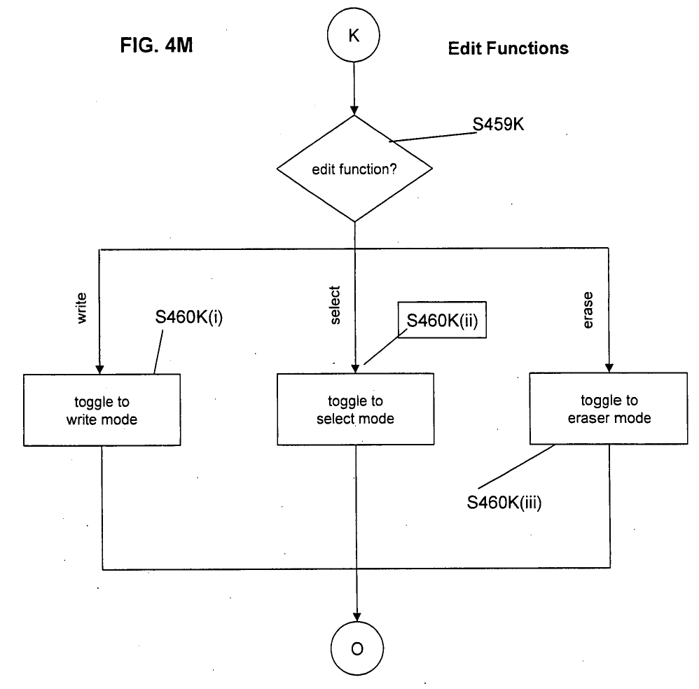

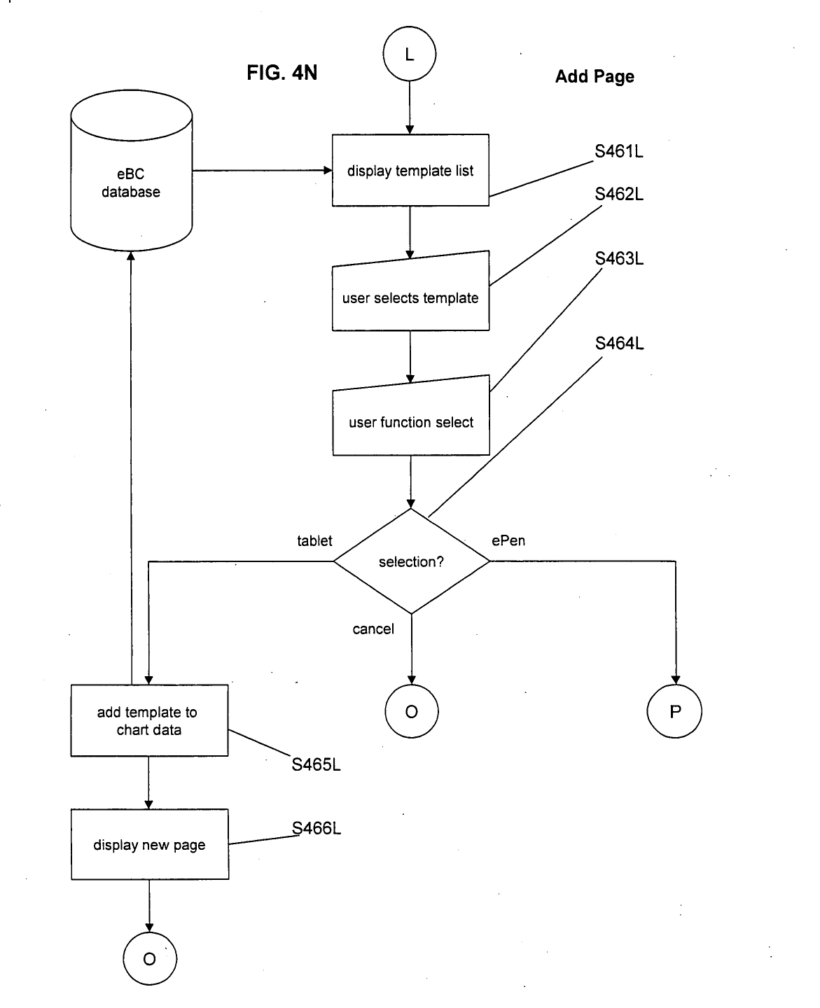

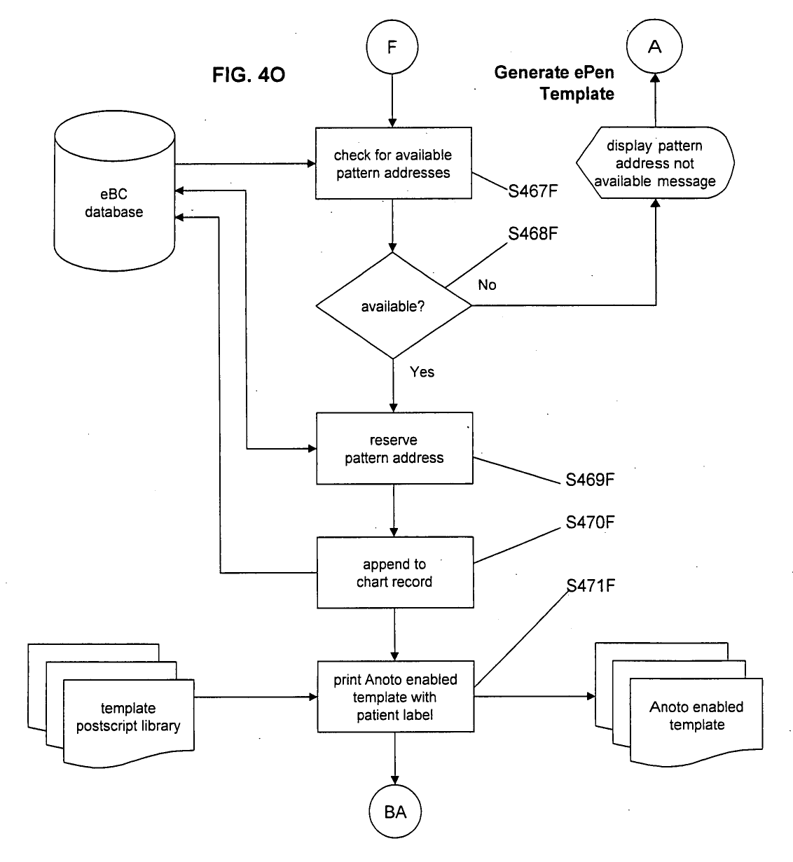

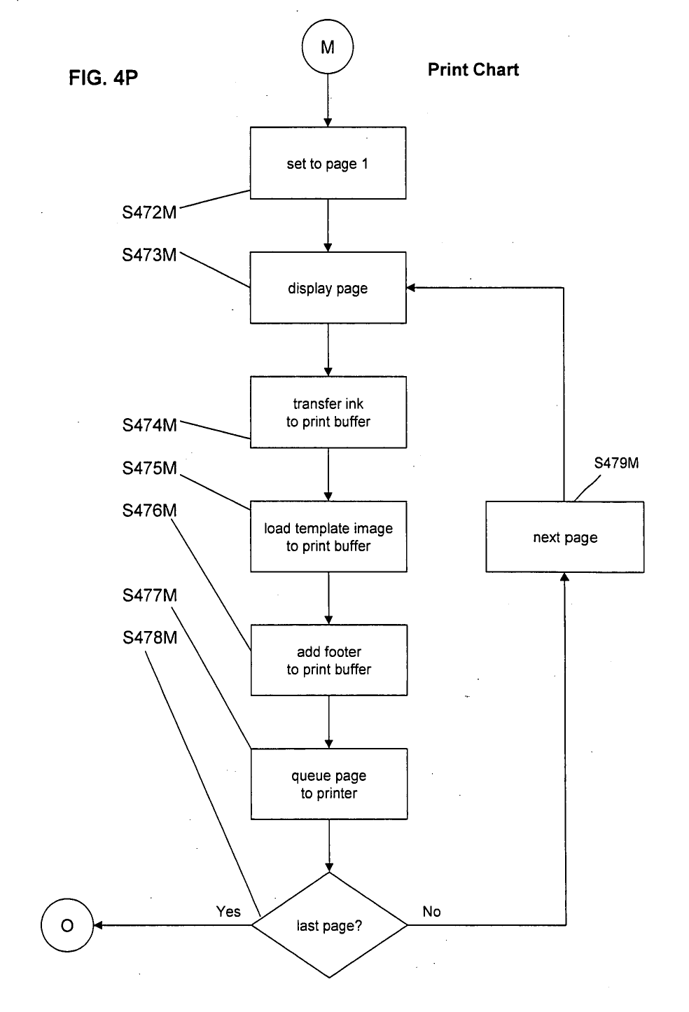

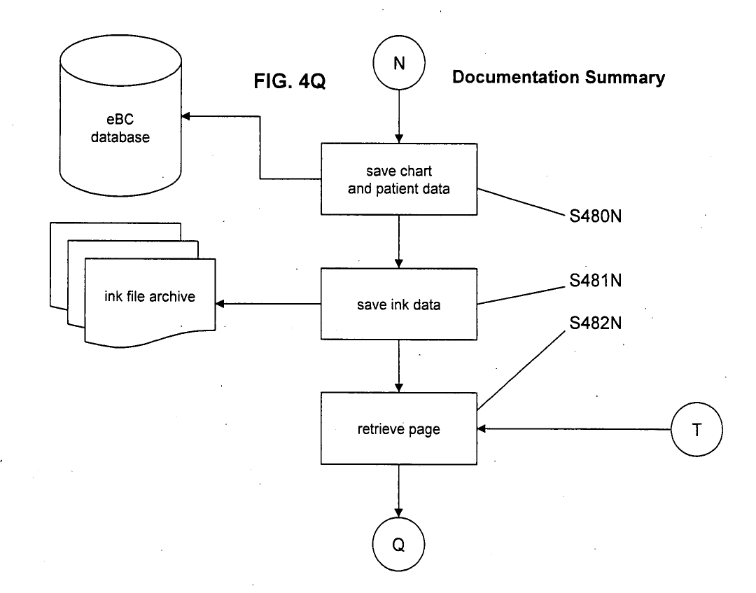

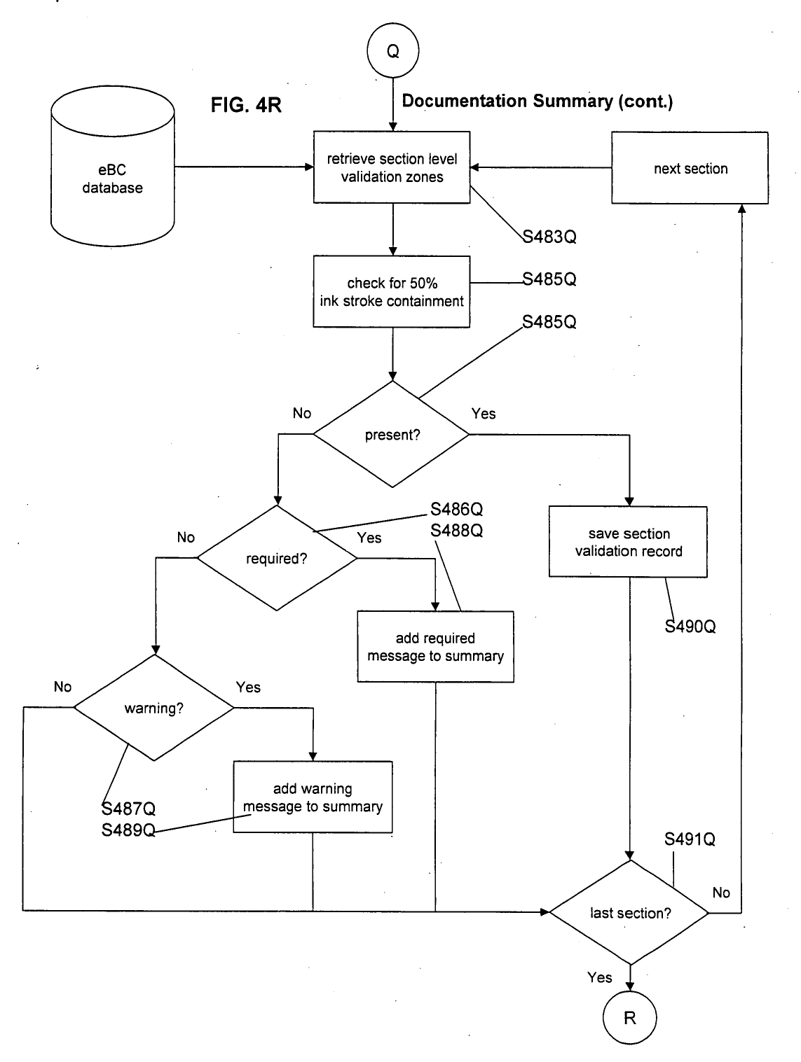

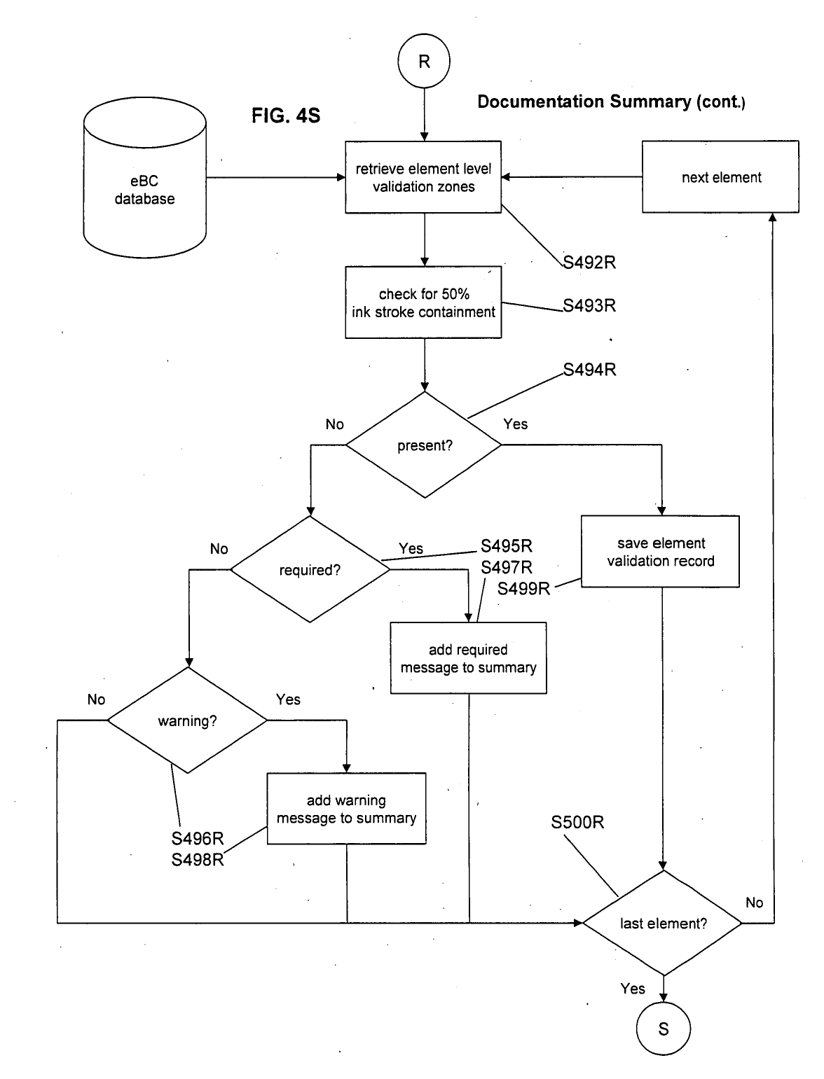

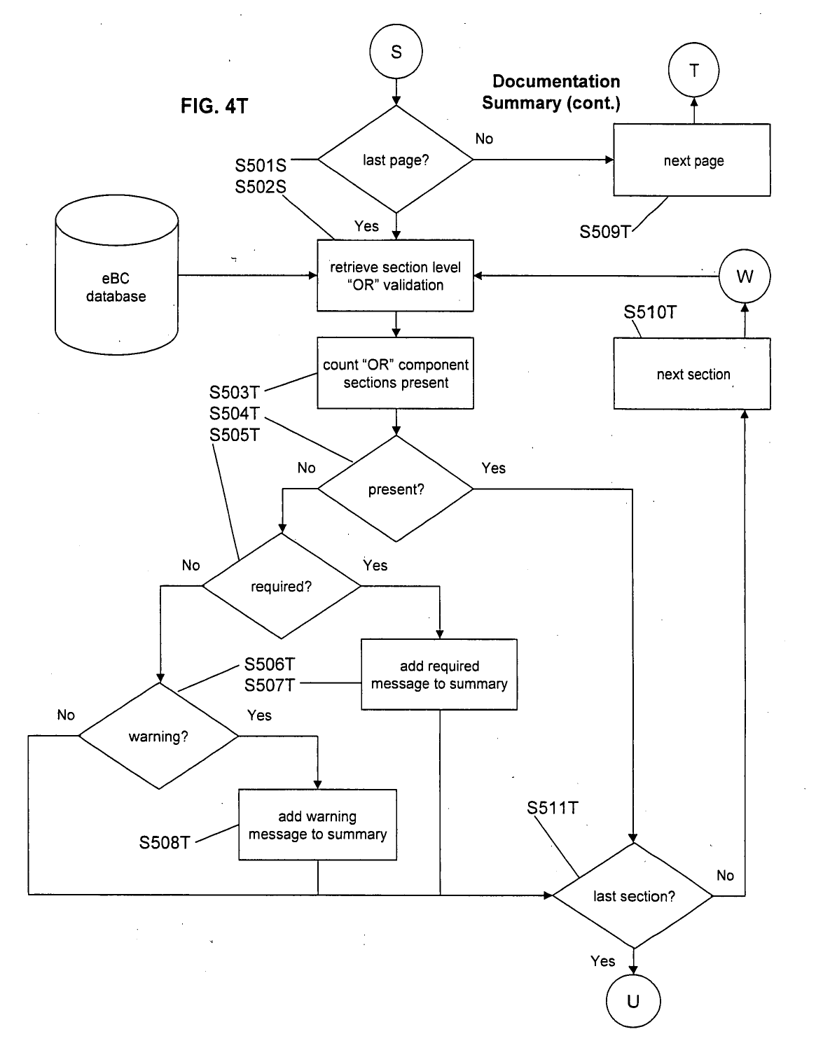

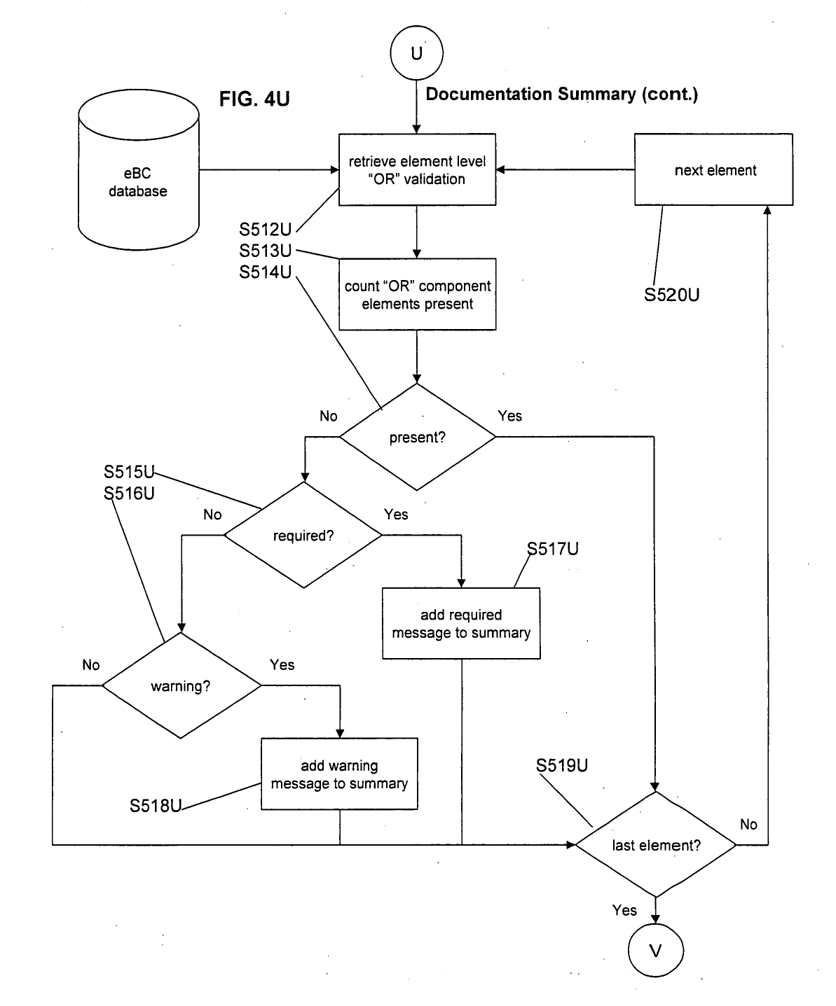

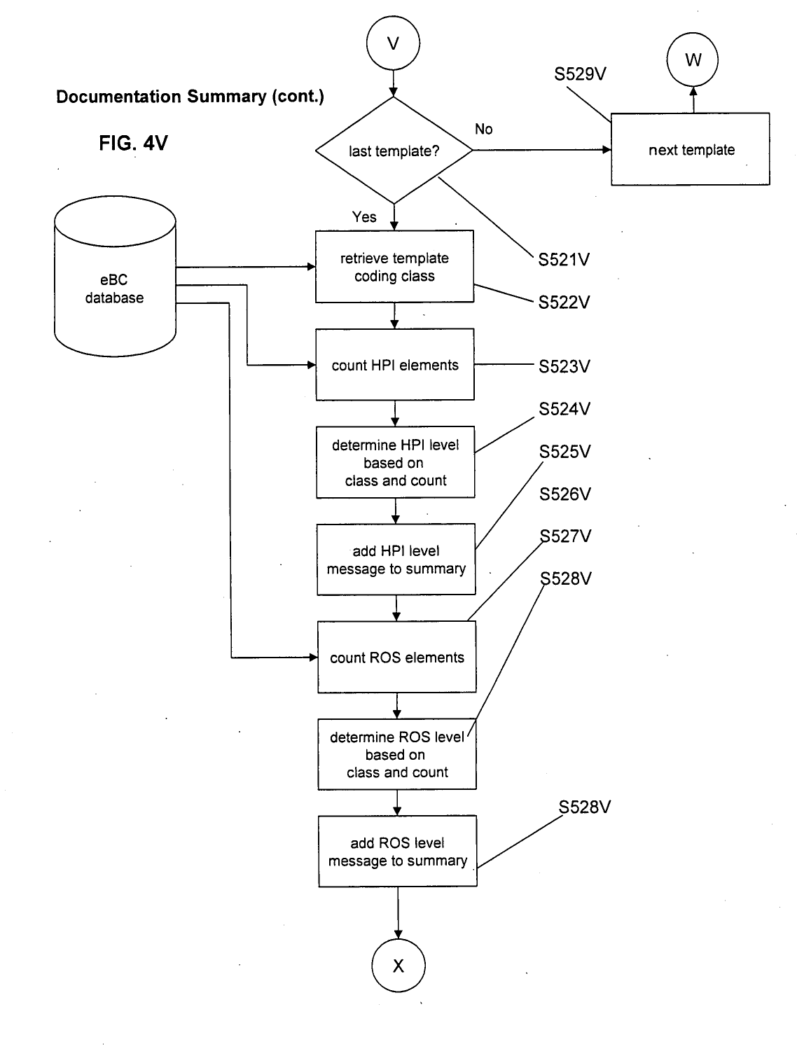

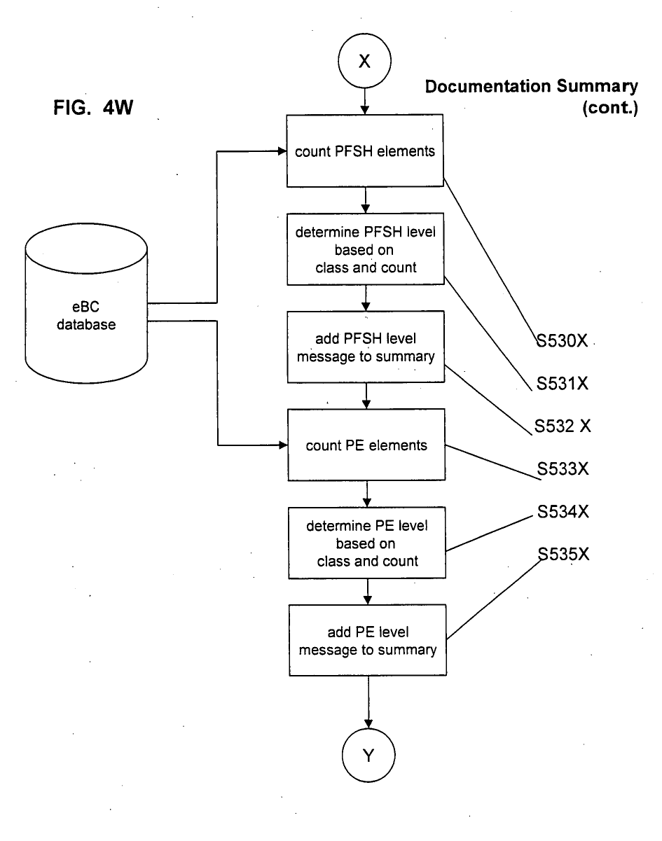

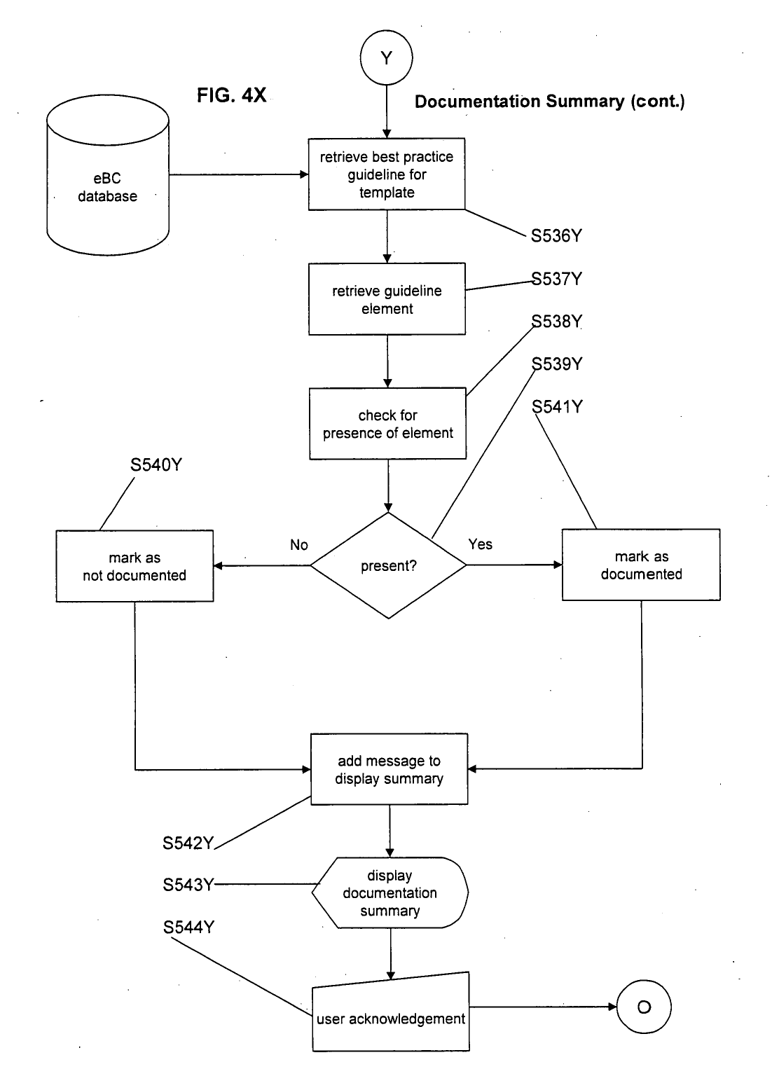

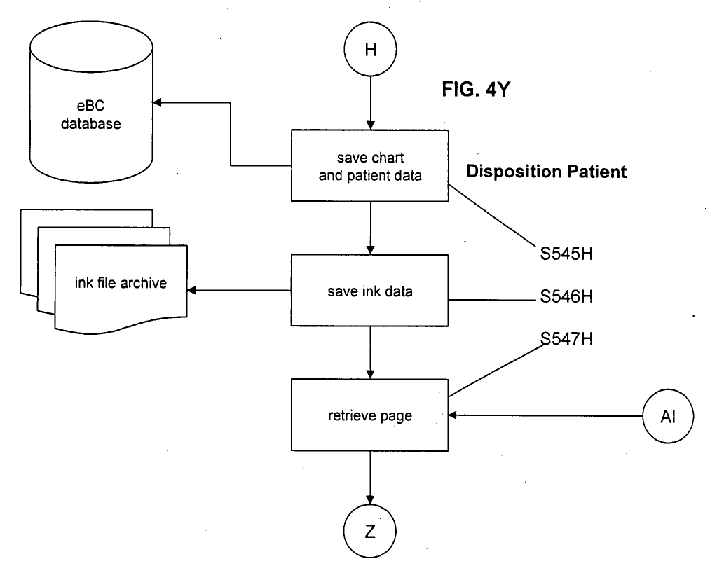

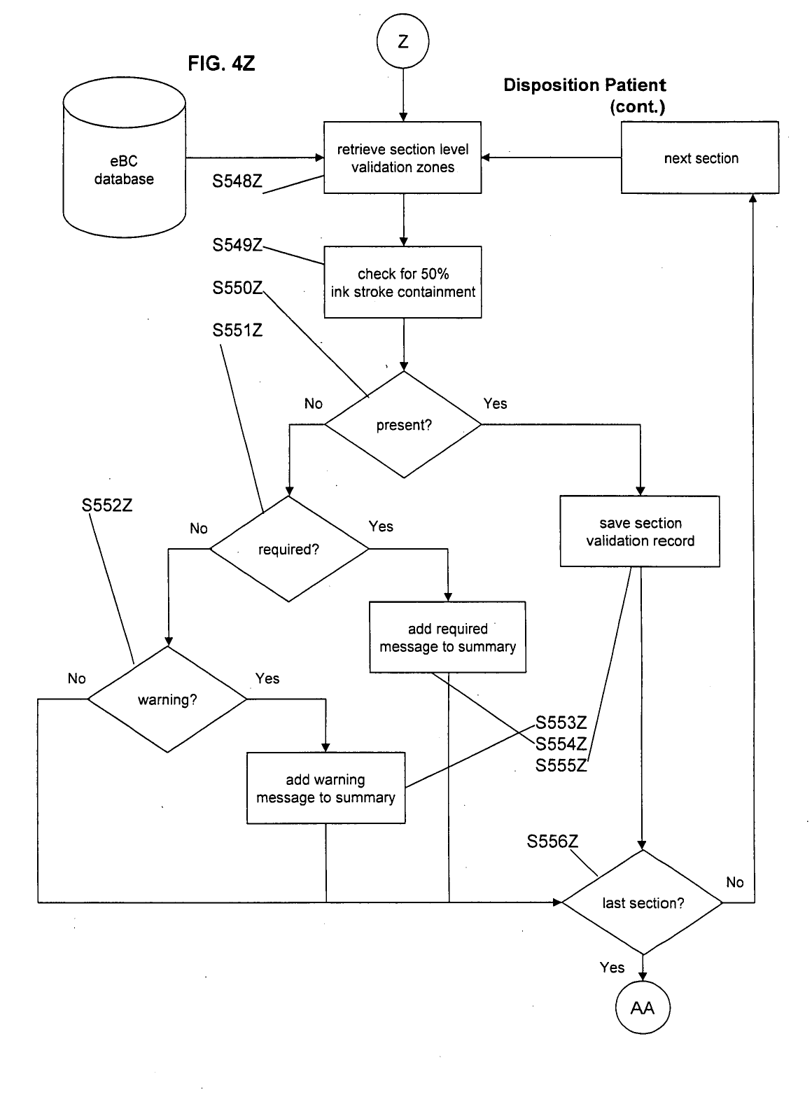

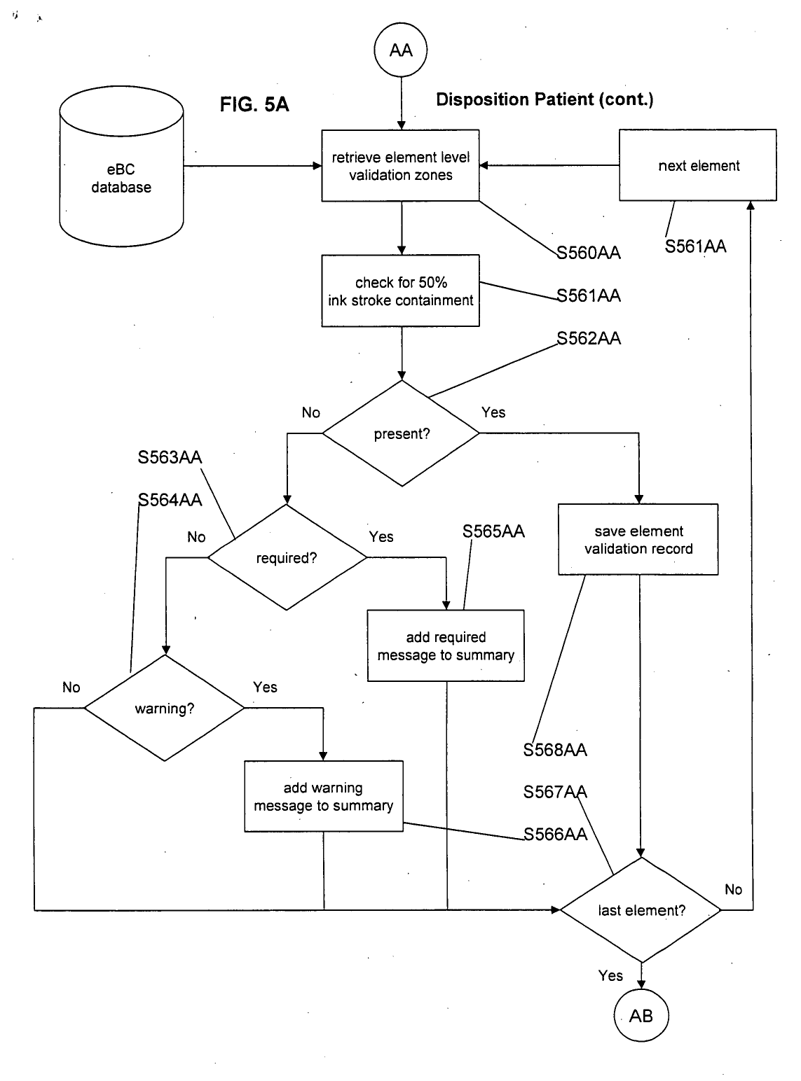

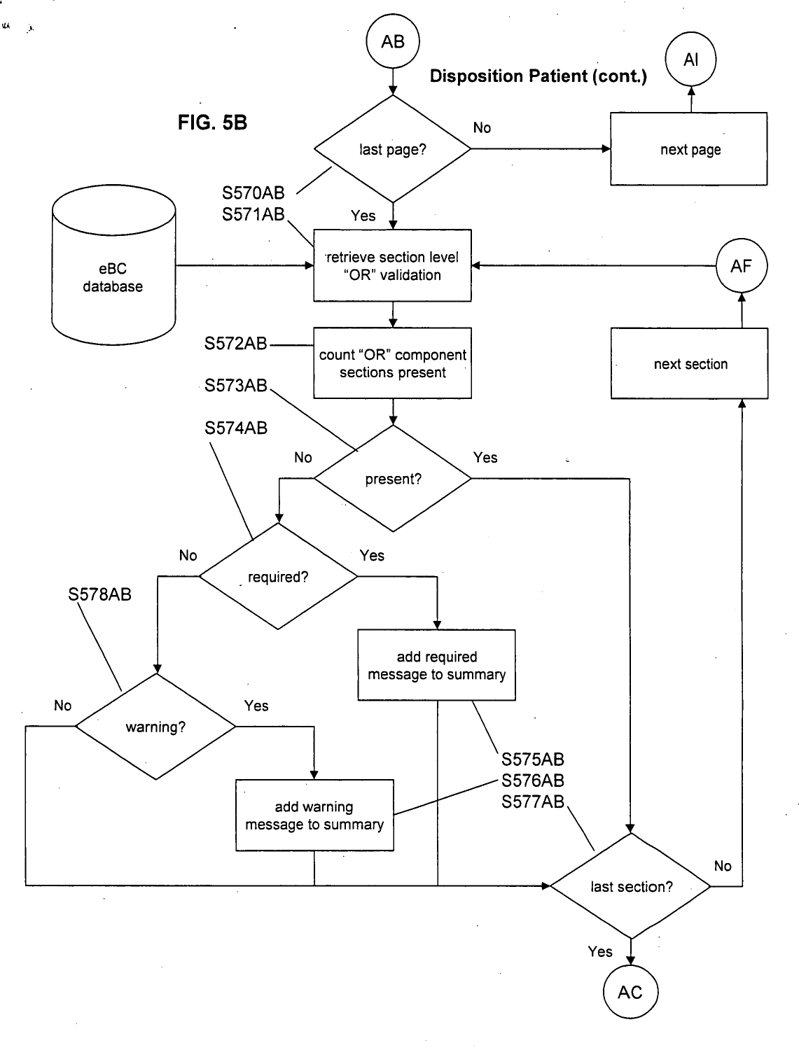

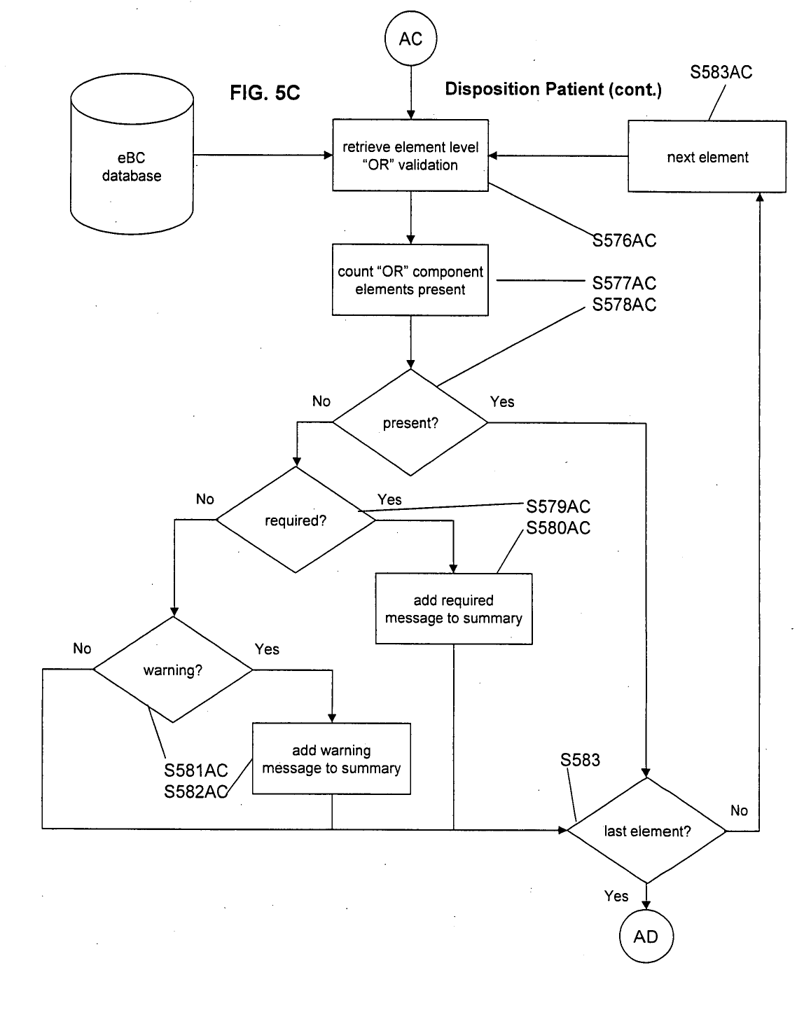

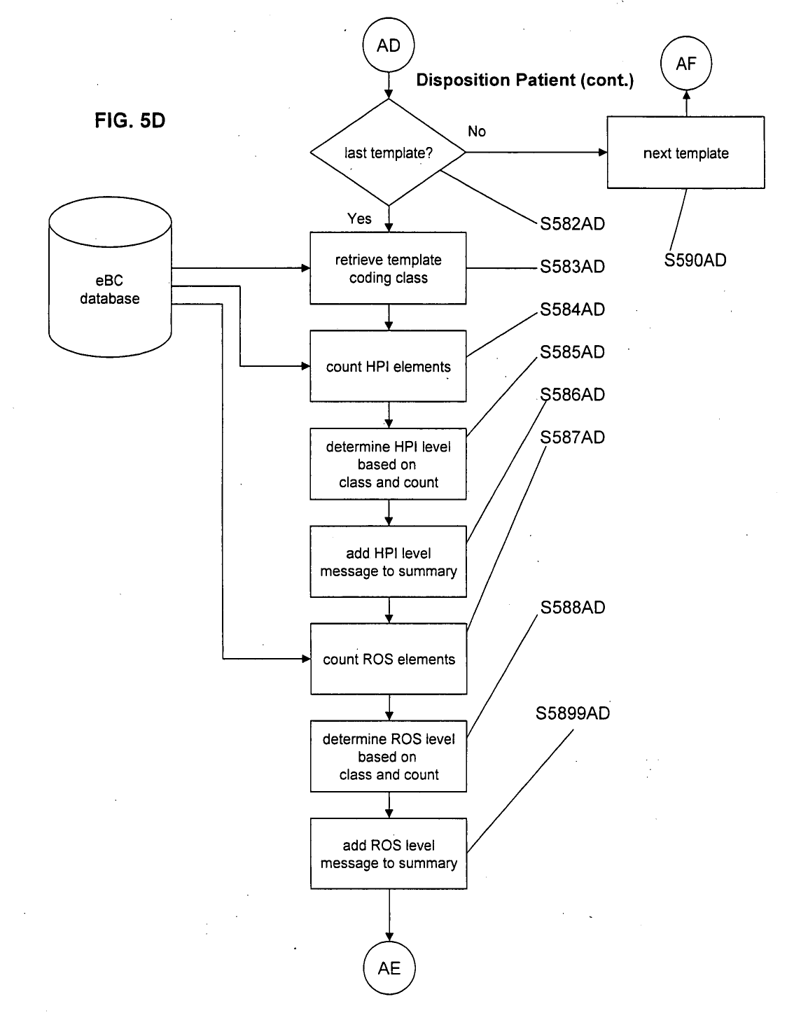

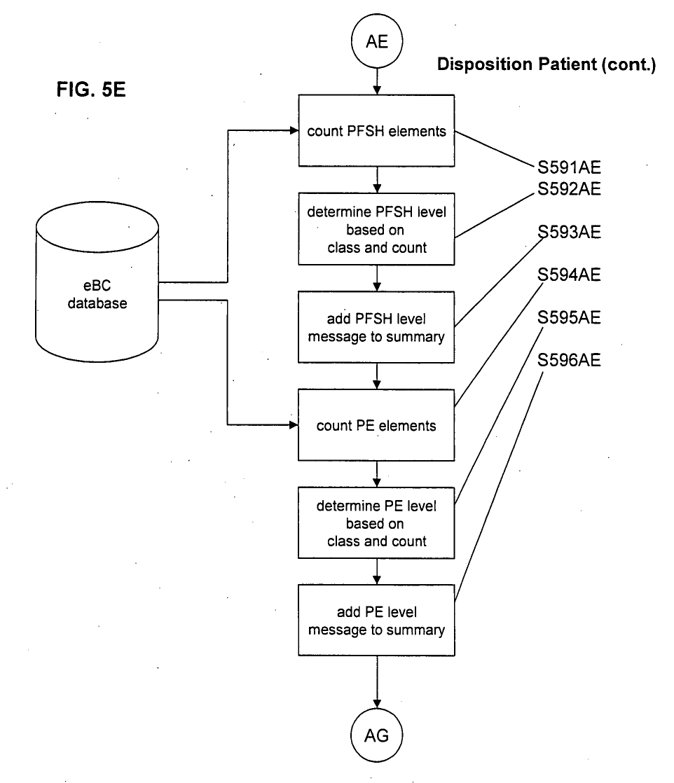

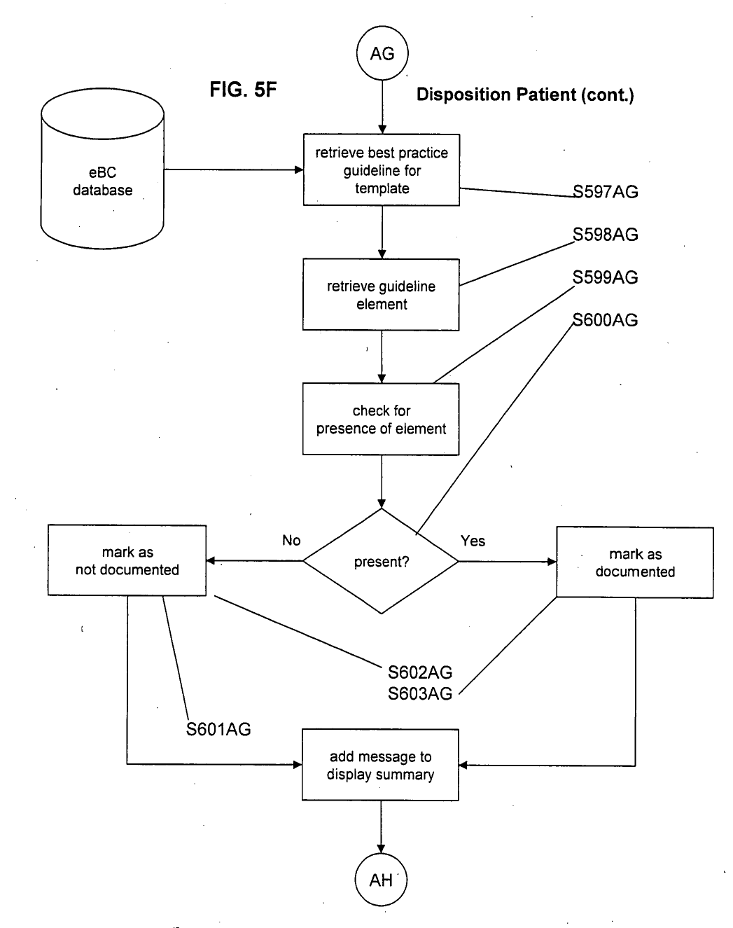

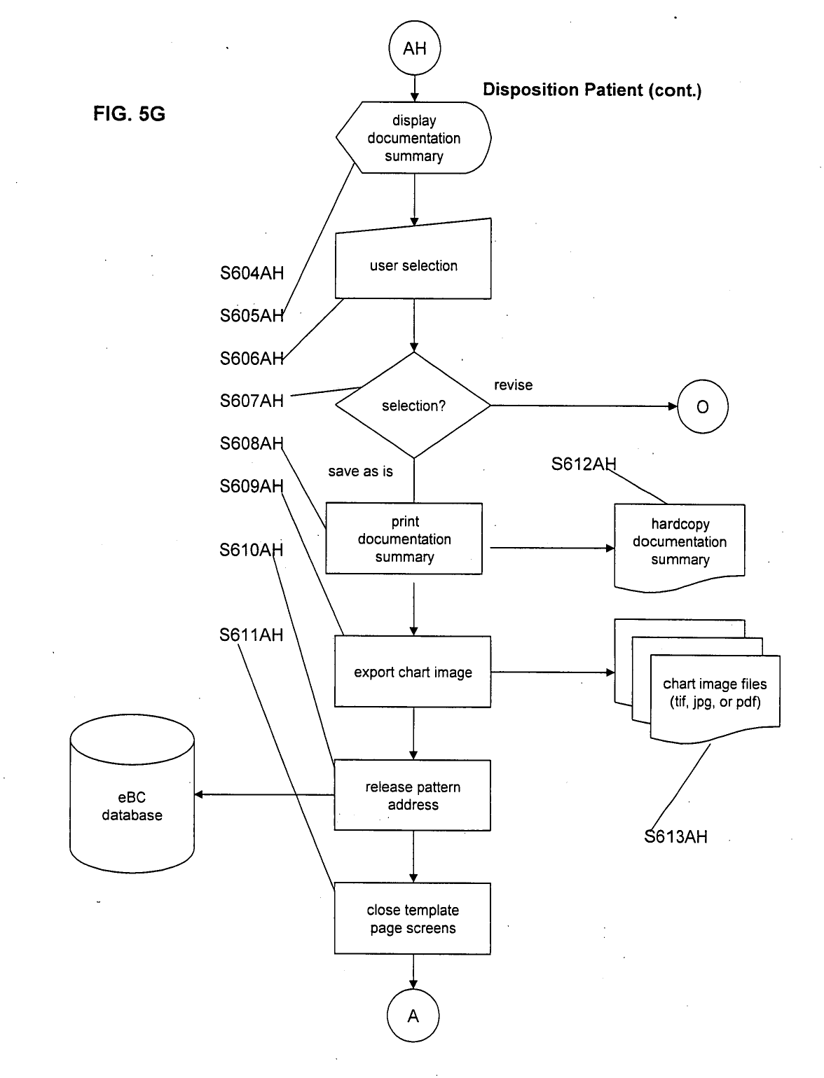

FIGS. 4A-4Z and 5A-5G are a series of flowcharts that are provided to show how the various functions of a method and a computer program according to the present invention can be practiced. It should be understood that the reference numbers do not represent a continuous series of steps that run from the first page to the last page of flowcharts, but rather branch off into various legs depending on the answers to questions in decision boxes. After the first page on FIG. 4A, each Figure has at least one letter identifying the leg where the flowchart may continue, and the suffix of each reference numeral identified in FIG. 4B to FIG. 5G has the corresponding letter of the path being followed. For example, FIG. 4A shows that at step 405, the program starts and the system is initialized at step 406. Steps 407-409 are for login and validation of a pin number (password). FIG. 4A is continued at circle A shown in FIG. 4B, where the patient list can be updated from the HL7 feed, the update template list is retrieved and from that the update incomplete chart list is displayed (steps 410A-413A), then there is a decision at step 415A as to which selection is desired, meaning the method steps can follow leg B if a patient is selected, leg C if an incomplete chart is selected, or leg D if a chart search is completed. FIG. 4B shows the patient leg, then at step 419B, there is a decision as to whether the medical provider is using a tablet P.C. (follows leg E in FIG. 4D) or a digital pen (follows leg F at FIG. 4O).

Referring back to FIG. 4D, there are various legs selectable by the toolbar function (s423E), wherein leg G is a save chart function, leg H is a patient disposition function, leg I is switch label, leg J is delete chart, leg K provides edit functions, leg L is add page, leg M is print, and leg N is the document summary function. FIG. 4E shows leg O is a display that a pattern address is not available, leg P (FIG. 4G) checks for available pattern addresses, leg Q (FIG. 4R) retrieves section level validation zones, leg R (FIG. 4S) retrieves element level validation zones, and leg S (FIG. 4T) count of component sections present are just some of the functions of the invention.

Still referring to the flowchart, the best practice guidelines are retrieved at leg Y (FIG. 4X), wherein a guideline element(s) is retrieved and its presence checked for in the document. At step s539Y, it the guideline element is not present, the chart is marked as not documented (s540Y) or documented (s541Y). There is, for example, more than one way to utilize the best practice guidelines, as leg AG (FIG. 5F) has the same functionality as leg Y, but this function is performed after completing leg AE (FIG. 5E).

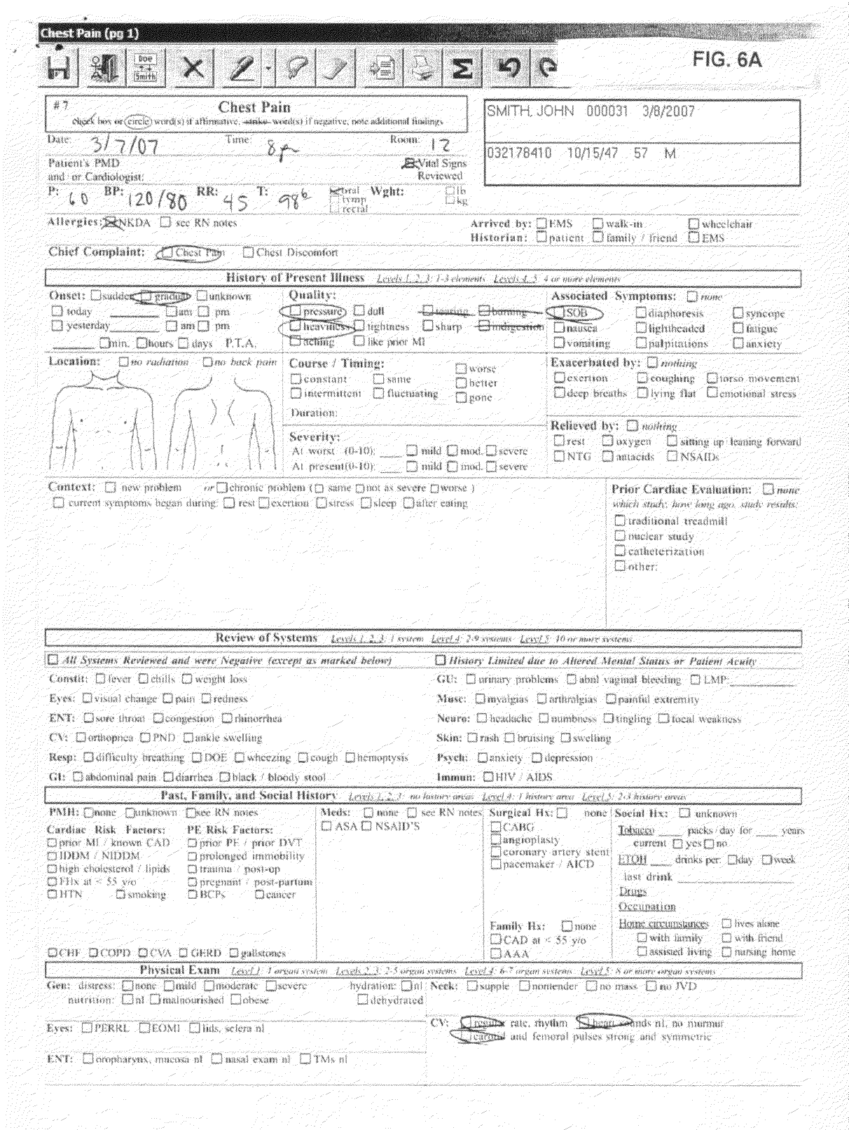

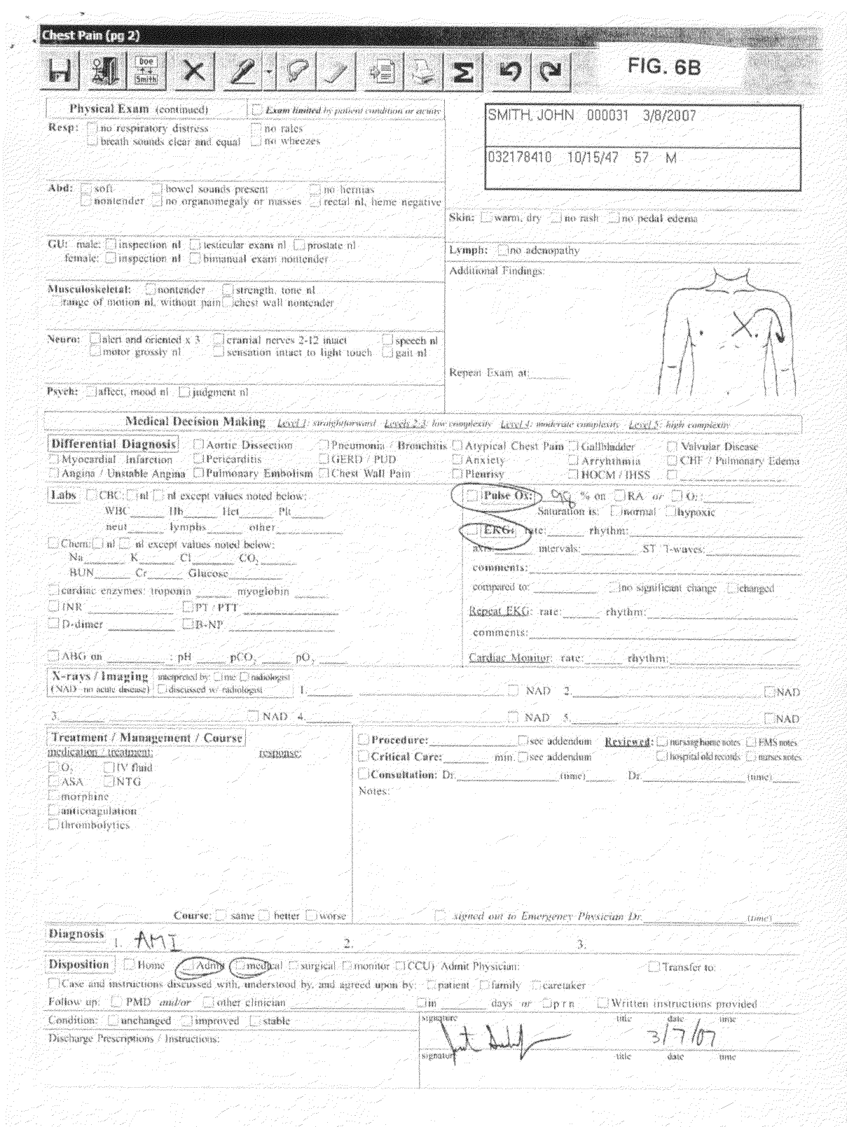

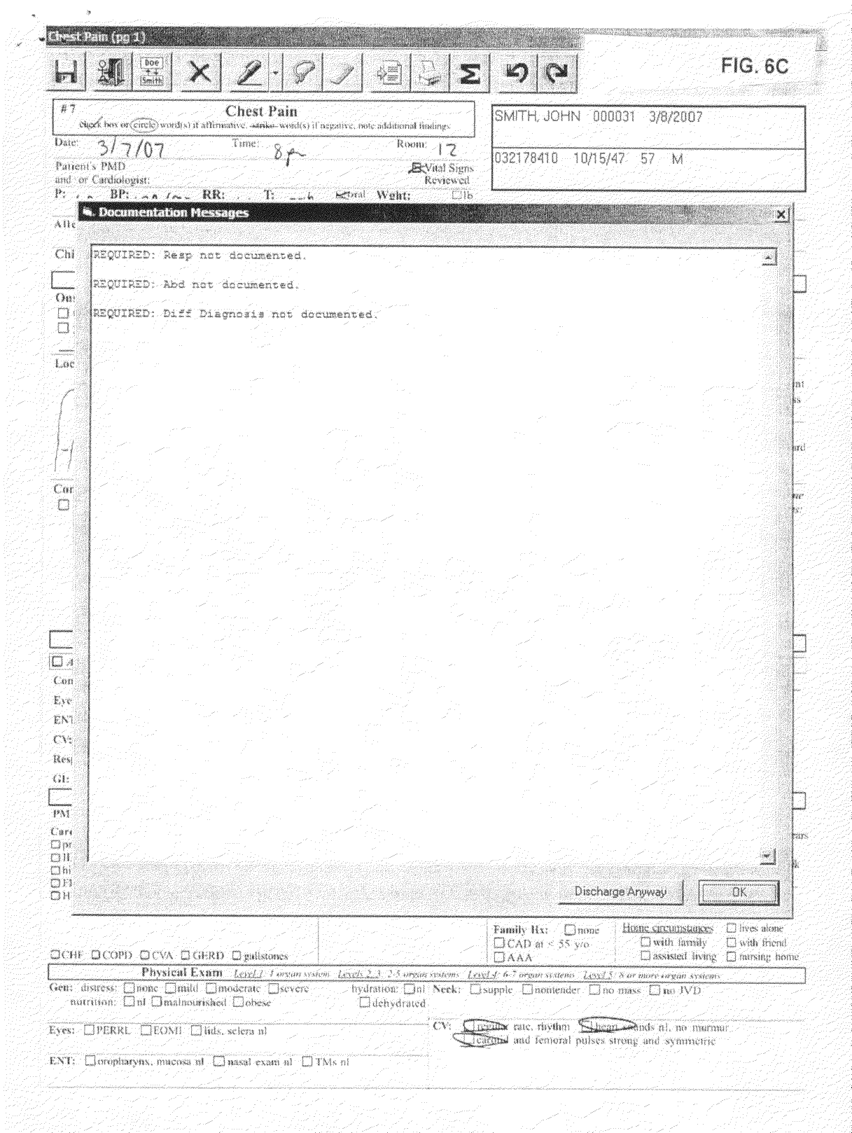

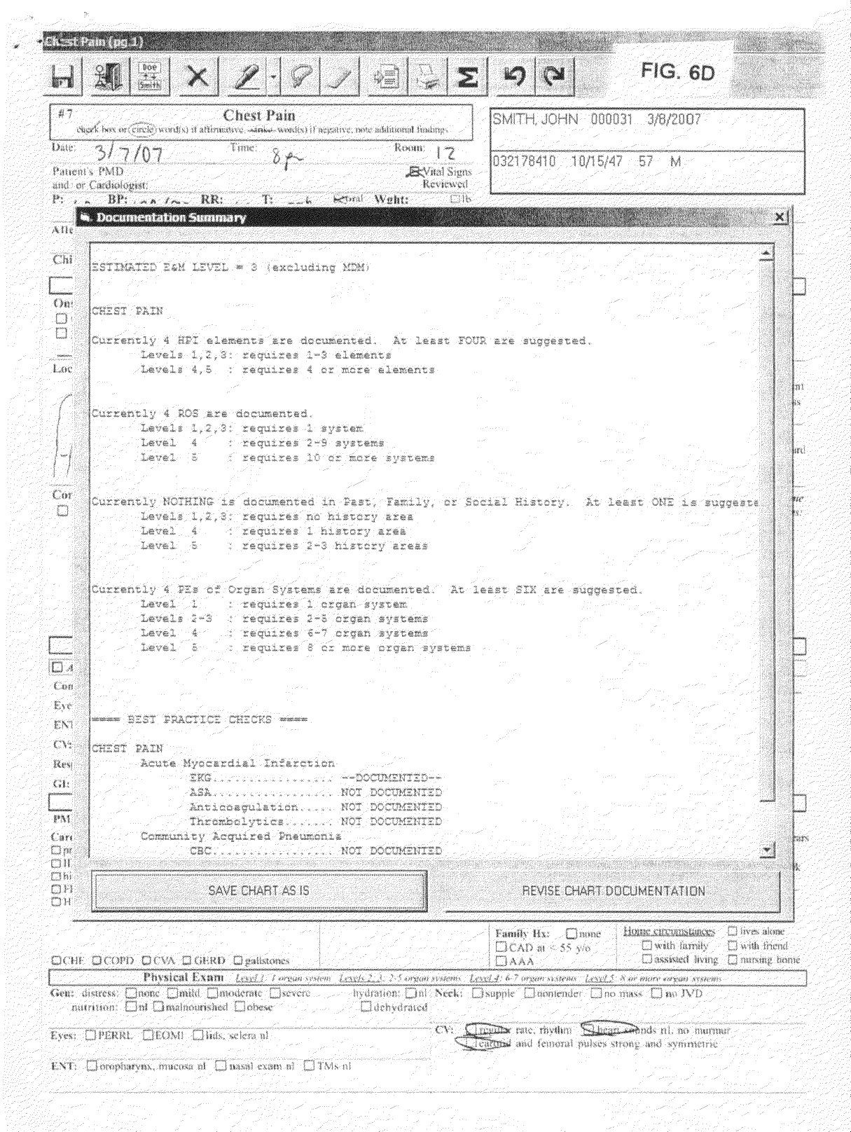

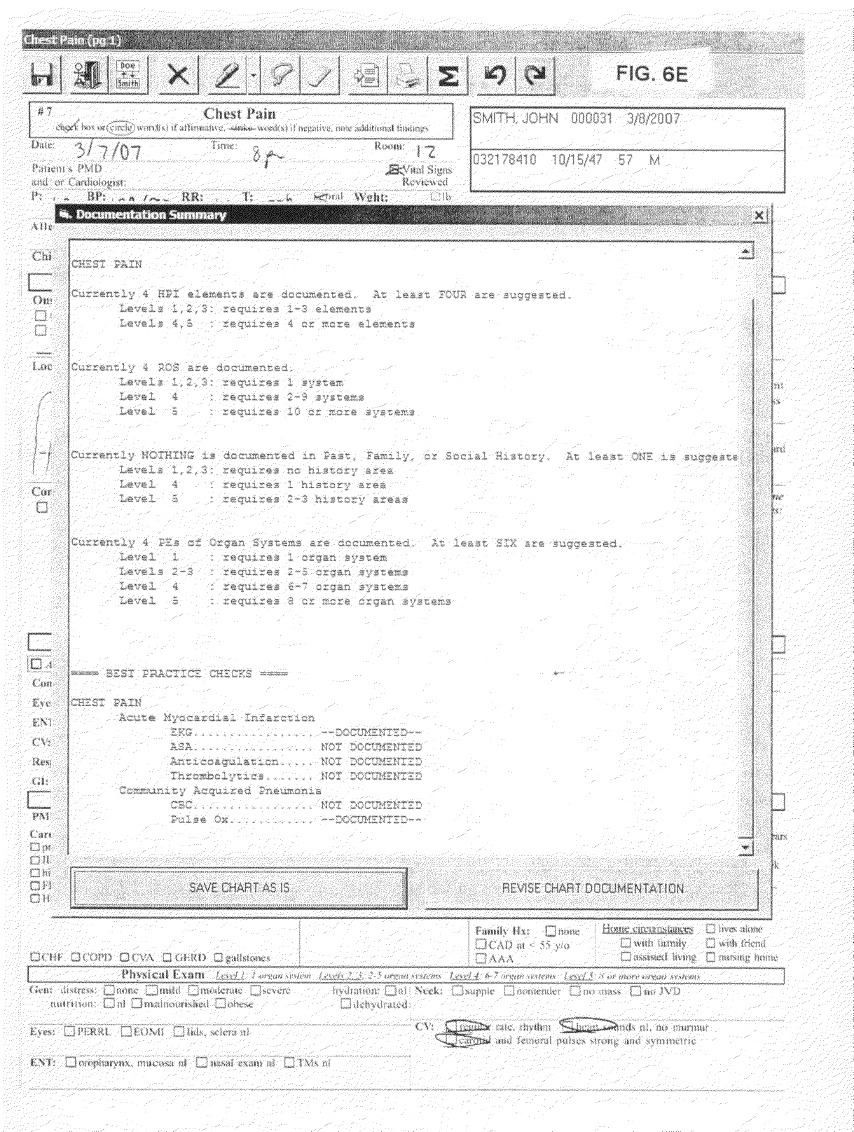

FIGS. 6A to 6E are examples of screen images captured from a working embodiment of the present invention. FIG. 6A shows how a screen snapshot may look using a chart that is specific to chest pain. The physician's hand-writing was transferred from the digital pen when it was docketed in the docketing station in communication with the system. FIG. 6B shows a screen snapshot of a Physical Exam chart, and FIG. 6C shows the result of a validation of the physician's information revealed a documentation message where three items were not documented on the chart, such as the respiratory information, abdominal inspection and differential diagnosis were all missing from the chart. At the bottom of the screen are “discharge anyway” and “okay” buttons, that can be clicked on by a pointing device (or enter pressed when selected) as a way of confirming that the physician is aware the data is missing. FIGS. 6D and 6E show how a documentation summary of the chart appears on the screen, along with best practice checks, which would help the physician to ensure that all of the items listed as “not documented” are addressed. Notice that the bottom of the screen has clickable buttons to save or revise the chart.

While the invention is shown and described primarily for the benefit of medical documentation, it is to be understood by a person of ordinary skill in the art that there are many uses and operations of the present invention that extended far beyond the medical field but are within the spirit of the invention and the scope of the appended claims, included but not limited to event notification, reservation systems, financial applications such as credit card applications, and many other fields that would benefit from real-time validation of recorded information and the checking as to whether best practice guidelines with or without prompts for the various disciplines are being followed. It should also be understood that items such as a summary button is but one way the writing device would request validation of the writing captured by the pen, and it could be an any other type of actuator triggered by any known means, including voice response. The validation module may provide validation upon request and/or at certain predetermined intervals of time, pen strokes, form count, etc.

We claim:

1. A system for electronic documentation and validation of information comprising:
a storage medium having one or more templates stored therein for use in a chart, said one or more templates having at least one of a required entry field and optionally a suggested entry field to receive documentation data entered by at least one of a digital pen and a stylus of a tablet P.C.;
an electronic chart module for performing at least one of retrieving and generating a chart for documentation data, said chart includes said one or more templates for receiving documentation data entered into the chart, and said electronic chart module communicating with said storage medium to store the documentation data;
a processor for validating in association with a validation sub-module of said electronic chart module for validating that said documentation data has been entered in said at least one required entry field of said one or more templates of the chart; and
said validation sub-module further providing chart validation comprising means for verifying an accuracy of the documentation data entered by said at least one of a digital pen and said stylus of a tablet P.C. by comparing said documentation data entered into said at least one required field of said one or more templates of said chart with documentation data guidelines in the storage medium.

2. The system according to claim 1, wherein the documentation data is entered with said digital pen, and said digital pen having a camera recording pen-strokes, and further comprising a chart capture sub-module that communicates with the digital pen via an Application Program Interface (API) for capturing documentation data recorded on the chart.

3. The system according to claim 2, wherein the chart is comprised of a material having an array of micro-dots printed thereon to document ink strokes made on the material by a plurality of pen-strokes by the digital pen, wherein a shape of said ink strokes being selected from the group consisting of a dot, a dash, a check-mark in a box, a circled word, a strikethrough, a written word, a forward slash, a back-slash, a multi-curved line and an asterisk.

4. The system according to claim 2, wherein the chart comprises electronic paper made of a bendable film substrate to document strokes made on the material by a plurality of pen-strokes by the digital pen, wherein a shape of pen-strokes being selected from the group consisting of a dot, a dash, a check-mark in a box, a circled word, a strikethrough, a written word, a forward slash, a back-slash, a multi-curved line and an asterisk

5. The system according to claim 2, wherein said means for verifying an accuracy of the documentation data comprises counting any ink strokes made on the chart.

6. The system according to claim 2, wherein said means for verifying an accuracy of the documentation data comprises counting any ink strokes made on said at least one required entry field and said suggested entry field of the chart.

7. The system according to claim 1, wherein the documentation data is entered with a stylus on a display of a tablet P.C., and said means for verifying an accuracy of the documentation data comprises counting any marks made on the display of the tablet P.C. within said at least one required entry field and said suggested entry field

8. The system according to claim 1, wherein said means for verifying accuracy includes displaying a summary field that is actuated by at least one of a pointing device, keyboard or touch, for providing interactive validation of the documentation data made on the chart.

9. The system according to claim 8, wherein said interactive validation includes displaying a quantity of required and suggested entry fields having documentation data at the time of validation.

10. The system according to claim 1, wherein said means for verifying accuracy includes displaying a patient disposition field that is actuated by at least one of a pointing device, keyboard or touch, for validating the documentation data made on the chart and includes displaying a quantity of required and suggested entry fields having documentation data at the patient disposition field is activated.

11. The system according to claim 10, further comprising a chart archive module for archiving and exporting a completed chart upon final disposition of the patient.

12. The system according to claim 1, further comprising a plurality of charts having one or more templates, wherein the one or more templates for use in a respective chart of said plurality of charts are customized.

13. The system according to claim 9, further comprising a direct edit sub-module for editing or completing the entry of documentation data on the chart.

14. The system according to claim 13, wherein the direct edit sub-module permits a user to update the chart by adding, deleting, or changing data in the chart entered by said at least one of a digital pen and stylus of a tablet P.C.

15. The system according to claim 1, wherein the chart comprises a medical chart, and said electronic chart module further comprises a patient list sub-module that is adapted to receive patient demographic information.

16. The system according to claim 15, wherein the patient demographic information is provided according to ANSI standard Health Level 7 (HL7).

17. The system according to claim 2, wherein the chart comprises a medical chart, and said electronic chart module further comprises a patient list module that is adapted to receive patient demographic information.

18. The system according to claim 1, further comprising a template generation sub-module for generating templates to be used in the chart.

19. The system according to claim 1, wherein the documentation data guidelines include best practices guidelines prompts for treatment of a patient at an emergency medical facility.

20. The system according to claim 19, wherein the best practice guidelines prompts include contraindications of prescribed treatment and medication with a patient's prescription drug use.

21. A computer program for electronic documentation and validation of data on a chart entered by at least one of a digital pen or a stylus of a tablet P.C., said program comprising computer-executable code recorded on machine readable data comprising:
an electronic chart module comprising code for performing at least one of retrieving and generating a chart for documentation data, the chart includes one or more templates for receiving documentation data entered into the chart, and said electronic chart module communicating with a storage medium to store the documentation data;
a chart capture sub-module of said electronic chart module comprising code for communicating with (1) a digital pen via an Application Program Interface (API) for capturing documentation data recorded on the chart; and (2) capturing data entered on a display of a tablet P.C.;
a validation sub-module of said electronic chart module comprising code for validating the documentation data has been entered in said at least one required entry field of said one or more templates of the chart, said validation sub-module providing a summary feature that begins the validation of the documentation data on the chart;
said validation sub-module further including code for counting any ink strokes made by the digital pen on said at least one required entry field and said suggested entry field of the chart.

22. The computer program according to claim 21, further comprising:
the charts retrieved or generated comprise health charts printed on a material including an array of micro-dots to facilitate capturing of ink strokes by a digital pen; and
the validation sub-module includes code for comparing a course of prescribed treatment entered on the health chart with best practice guidelines stored on a storage medium;
a direct edit sub-module comprising code for editing charts that are incomplete or contain incorrect information as determined by the validation sub-module; and
a chart archive sub-module comprising code for archiving and exporting the health chart after the documentation data has been documented and validated.

23. A method for electronic documentation and validation of data entered by at least one of a digital pen or a stylus of a tablet P.C., said method comprising:
(a) performing at least one of retrieving and generating a chart for documentation data, the chart includes one or more templates for receiving documentation data entered into the chart, and communicating with a storage medium to store the documentation data;
(b) communicating with at least one of: (1) a digital pen via an Application Program Interface (API) for capturing documentation data recorded on the chart; and (2) capturing data entered on a display of a tablet P.C.;
(c) validating the documentation data has been entered in said at least one required entry field of said one or more templates of the chart by: (i) counting any ink strokes made by the digital pen on at least one a required entry field and a suggested entry field of the chart, or (ii) counting marks made by a stylus on a display of a P.C.; and
(d) providing an edit mode to edit any missing data in the chart.

24. The method according to claim 23 further comprising:
the retrieved or generated chart comprises a health chart for a plurality or respective health problems, the charts being printed on a material including an array of micro-dots to facilitate capturing of ink strokes by a digital pen; and
the validation in step (c) includes comparing a course of prescribed treatment entered on the health chart with best practice guidelines stored on a storage medium;
editing charts that are incomplete or contain incorrect information as determined by the validation step (c); and
archiving and exporting the health chart after the documentation data has been documented and validated.

25. A warning system for a writing device used in an electronic documentation and validation system, comprising:
a writing device that electronically records handwritten information on a chart, said writing device having drivers and an Application Program interface (API), an electronic chart module including a chart capture sub-module that communicates with the writing device via the API;
a validation sub-module for validating documentation data entered on the chart; and
a warning means including an alarm arranged on or within the writing device to notify a user of the writing device of an error found by the validation sub-module.

26. The warning system according to claim 25, wherein the writing device includes an actuator to request validation of recorded information.

27. The warning system according to claim 25, wherein the writing device comprises a digital pen and the chart comprises a material selected from the group consisting of paper containing an array of microdots for recording ink strokes, electronic paper comprised of a bendable film substrate, electronic paper comprised of cellulose, and paper compatible for use with an Optical Character Recognition system; wherein
the chart comprises a plurality of health charts for respective ailments; and
the validation sub-module checks for errors by counting recorded fields and for compliance with best health practices; and
the warning means includes a range of warnings to the writing device to let the user know about the severity of the error based on the type of warning.
